(19) United States
(12) Patent Application Publication
(10) Pub. No.: US 2007/0174972 A1
(43) Pub. Date: Aug. 2, 2007

(54) SPANDEX HAVING ENHANCED WHITENESS, AND FABRICS AND GARMENTS COMPRISING THE SAME

(75) Inventors: Thomas Edward Carney, Orient, OH (US); Mary J. Wahlstrom, Waynesboro, VA (US); Geoffrey D. Hietpas, Newark, DE (US)

Correspondence Address: INVISTA NORTH AMERICA S.A.R.L., THREE LITTLE FALLS CENTRE/1052, 2801 CENTERVILLE ROAD, WILMINGTON, DE, 19808, US

(73) Assignee: INVISTA North America S.a r.I., Wilmington, DE (US)

(21) Appl. No.: 11/559,165

(22) Filed: Nov. 13, 2006

Related U.S. Application Data
(60) Provisional application No. 60/736,976, filed on Nov. 14, 2005.

(51) Int. Cl. C11D 3/00

(52) U.S. Cl. 8/115.51

(57) ABSTRACT

The invention provides spandex having an initial CIE whiteness of at least about 95 as measured by AATCC Test Method 110-1994, the spandex comprising an optical brightener selected from the group consisting of an oxazole, a biphenyl, a coumarin, a stilbene, a pyrazolene, a rhodamine, and a fluorescein, or a combination of such members, and an ultraviolet screener selected from the group consisting of a triazine, a benzotriazole, an oxalanilide, a benzophenone, and a bismalonate, or a combination of such members.

### CROSS-REFERENCE TO RELATED APPLICATIONS

This application claims the benefit of U.S. Application No. 60/736,976, filed on Nov. 14, 2005, which is incorporated herein by reference.

### BACKGROUND OF THE INVENTION

### Field of the Invention

This invention relates to spandex which has enhanced initial whiteness, as well as spandex which has improved whiteness retention after environmental exposure. This invention also relates to spandex which has good property retention after extended exposure to ultraviolet (UV) radiation. The spandex comprises an optical brightener and a UV screener, and may optionally further comprise a hindered amine light stabilizer. This invention also relates to a method for imparting whiteness to spandex, a method for adjusting the initial whiteness of spandex to a desired level, a method for imparting whiteness retention after scouring or after environmental exposure to spandex, and a method for imparting property retention to spandex after extended exposure to ultraviolet radiation. Additionally, this invention relates to fabric comprising spandex, the fabric having enhanced initial whiteness and improved whiteness retention after environmental exposure. Furthermore, this invention relates to a method to achieve an enhanced whiteness in fabric comprising spandex and in garments comprising such fabric.

### SUMMARY OF RELATED ART

Spandex is the generic name for a manufactured fiber in which the fiber-forming substance is a long-chain synthetic polymer comprised of at least 85% of a segmented polyurethane. Spandex is also referred to as elastane. Spandex fibers made from polyether-based polyurethane polymers are known to be susceptible to discoloration under certain environmental conditions, for example under exposure to ultraviolet light (UV) or in the presence of atmospheric gases such as nitrogen dioxide (NO₂), which is an important constituent of combustion gases and atmospheric smog. Improved resistance to the environment under such conditions is a desirable attribute and may be quantified as “whiteness retention.” Discoloration is sometimes referred to as yellowing.

Additives have been used to enhance the whiteness of fibers. For example, the use of fluorescent whitening agents for whitening synthetic fiber materials is disclosed in U.S. Pat. No. 4,559,150. A fluorescent elastic yarn containing a “spun-in” additive is disclosed in United States Published Patent Application 2003/0198809. It is also known to use additives to enhance whiteness retention of fibers through environmental exposures. For example, a polyether-based spandex fiber with improved resistance to nitrogen dioxide (NO₂) is disclosed in U.S. Pat. No. 4,504,612. Additives for spandex which provide protection against discoloration due to exposure to fumes, light, and heat are disclosed in U.S. Pat. No. 5,219,909. The use in spandex of triazine UV absorbers, alone or in combination with hindered amine light stabilizers, is disclosed in U.S. Pat. No. 6,867,250.

The use of additives to enhance spandex fiber whiteness or to provide whiteness retention can incur additional cost and add complexity to the spandex manufacturing process. Furthermore, the use of additives to impart certain characteristics, such as initial whiteness or whiteness retention, can have an unintended consequence such as negatively impacting other desirable spandex characteristics, for example tenacity at break, elongation at break, or other properties. Thus, while new additives which can impart whiteness or whiteness retention to spandex, and new methods for providing whiteness or whiteness retention to spandex fibers and the fabrics and textile articles comprising them, continue to be sought, spandex which also has property retention after extended exposure to UV radiation is sought as well.

### SUMMARY OF THE INVENTION

In some embodiments are a spandex having an initial CIE whiteness of at least about 95 as measured by AATCC Test Method 110-1994, the spandex comprising: an optical brightener selected from the group consisting of an oxazole, a biphenyl, a coumarin, a stilbene, a pyrazolene, a rhodamine, and a fluorescein, or a combination of such members; and an ultraviolet screener selected from the group consisting of a triazine, a benzotriazole, an oxalanilide, a benzophenone, and a bismalonate, or a combination of such members.

In some embodiments are a spandex including an optical brightener selected from the group consisting of an oxazole, a biphenyl, a coumarin, a stilbene, a pyrazolene, a rhodamine, and a fluorescein, or a combination of such members; and an ultraviolet screener selected from the group consisting of a triazine, a benzotriazole, an oxalanilide, a benzophenone, and a bismalonate, or a combination of such members, in an amount sufficient for the percent growth of the spandex after 12 hours of exposure to ultraviolet radiation to be less than 16%.

In some embodiments are a fabric including at least one weight percent spandex, the spandex comprising an optical brightener selected from the group consisting of an oxazole, a biphenyl, a coumarin, a stilbene, a pyrazolene, a rhodamine, and a fluorescein, or a combination of such members; and an ultraviolet screener selected from the group consisting of a triazine, a benzotriazole, an oxalanilide, a benzophenone, and a bismalonate, or a combination of such members, wherein the fabric has whiteness retention greater than that of a comparison fabric made in the same way but with spandex lacking an optical brightener and a UV screener.

Also provided in some embodiments are spandex compositions having enhanced whiteness that include an optical brightener and an antioxidant such as those having at least one unsymmetrically di-hindered hydroxyphenyl group in the absence of a UV screener. In other words, no UV screener has been added to the spandex composition.

Also provided are fabrics including the spandex of some embodiments.

Also provided are garments or textile articles including the fabrics of the some embodiments.

Some embodiments further provide a method for imparting whiteness to spandex. The method includes a) contacting a polyether glycol selected from the group consisting of polyethyleneether glycol, polytrimethyleneether glycol, poly(tetramethyleneether) glycol, poly(tetramethylene-co-2-methyltetramethyleneether) glycol, poly(tetramethylene-co-ethyleneether) glycol and mixtures thereof, or a polyester glycol selected from the group consisting of reaction products of (i) ethylene glycol, propylene glycol, butylene glycol, 2,2-dimethyl-1,3-propanediol, and mixtures thereof, and (ii) terephthalic acid, succinic acid, adipic acid, azelaic acid, sebacic acid, and dodecanedioic acid, and mixtures thereof, with at least one diisocyanate; b) contacting the reaction product of step a) with at least one chain extender and, optionally, with a chain terminator; c) contacting the reaction product of step b) with an optical brightener and an ultraviolet screener in an amount sufficient to impart whiteness to the spandex, or alternatively, contacting the reaction product of step b) with an optical brightener and an antioxidant including at least one unsymmetrically di-hindered hydroxyphenyl group; and spinning the product of c) to form spandex, wherein the optical brightener is selected from the group consisting of an oxazole, a biphenyl, a coumarin, a stilbene, a pyrazolene, a rhodamine, and a fluorescein, or a combination of such members; and the ultraviolet screener is selected from the group consisting of a triazine, a benzotriazole, an oxalanilide, a benzophenone, and a bismalonate, or a combination of such members.

Also provided is a method for adjusting the initial whiteness of spandex to a desired level. The method includes a) contacting a polyether glycol selected from the group consisting of polyethyleneether glycol, polytrimethyleneether glycol, poly(tetramethyleneether) glycol, poly(tetramethylene-co-2-methyltetramethyleneether) glycol, poly(tetramethylene-co-ethyleneether) glycol and mixtures thereof, or a polyester glycol selected from the group consisting of reaction products of (i) ethylene glycol, propylene glycol, butylene glycol, 2,2-dimethyl-1,3-propanediol, and mixtures thereof, and (ii) terephthalic acid, succinic acid, adipic acid, azelaic acid, sebacic acid, and dodecanedioic acid, and mixtures thereof, with at least one diisocyanate; b) contacting the reaction product of step a) with at least one chain extender and, optionally, with a chain terminator; c) contacting the reaction product of step b) with an optical brightener and an ultraviolet screener in an amount sufficient to provide the desired whiteness level to the spandex, or alternatively, contacting the reaction product of step b) with an optical brightener and an antioxidant including at least one unsymmetrically di-hindered hydroxyphenyl group; and spinning the product of c) to form spandex, wherein the optical brightener is selected from the group consisting of an oxazole, a biphenyl, a coumarin, a stilbene, a pyrazolene, a rhodamine, and a fluorescein, or a combination of such members; and the ultraviolet screener is selected from the group consisting of a triazine, a benzotriazole, an oxalanilide, a benzophenone, and a bismalonate, or a combination of such members.

Also provided is a method for imparting whiteness retention after scouring or after environmental exposure to combustion fumes, nitrogen dioxides fumes, ultraviolet radiation, heat, or chlorine bleach to spandex. The method includes a) contacting a polyether glycol selected from the group consisting of polyethyleneether glycol, polytrimethyleneether glycol, poly(tetramethyleneether) glycol, poly(tetramethylene-co-2-methyltetramethyleneether) glycol, poly(tetramethylene-co-ethyleneether)glycol and mixtures thereof, or a polyester glycol selected from the group consisting of reaction products of (i) ethylene glycol, propylene glycol, butylene glycol, 2,2-dimethyl-1,3-propanediol, and mixtures thereof, and (ii) terephthalic acid, succinic acid, adipic acid, azelaic acid, sebacic acid, and dodecanedioic acid, and mixtures thereof, with at least one diisocyanate; b) contacting the reaction product of step a) with at least one chain extender and, optionally, with a chain terminator; c) contacting the reaction product of step b) with an optical brightener and an ultraviolet screener in an amount sufficient to provide whiteness retention to the spandex after scouring or after environmental exposure, or alternatively, contacting the reaction product of step b) with an optical brightener and an antioxidant including at least one unsymmetrically di-hindered hydroxyphenyl group; and spinning the product of c) to form spandex, wherein the optical brightener is selected from the group consisting of an oxazole, a biphenyl, a coumarin, a stilbene, a pyrazolene, a rhodamine, and a fluorescein, or a combination of such members; and the ultraviolet screener is selected from the group consisting of a triazine, a benzotriazole, an oxalanilide, a benzophenone, and a bismalonate, or a combination of such members.

Also provided is a method for imparting to spandex property retention of tenacity at break after 12 hours exposure to ultraviolet radiation The method includes a) contacting a polyether glycol selected from the group consisting of polyethyleneether glycol, polytrimethyleneether glycol, poly(tetramethyleneether) glycol, poly(tetramethylene-co-2-methyltetramethyleneether) glycol, poly(tetramethylene-co-ethyleneether) glycol and mixtures thereof, or a polyester glycol selected from the group consisting of reaction products of (i) ethylene glycol, propylene glycol, butylene glycol, 2,2-dimethyl-1,3-propanediol, and mixtures thereof, and (ii) terephthalic acid, succinic acid, adipic acid, azelaic acid, sebacic acid, and dodecanedioic acid, and mixtures thereof, with at least one diisocyanate; b) contacting the reaction product of step a) with at least one chain extender and, optionally, with a chain terminator; c) contacting the reaction product of step b) with an optical brightener and an ultraviolet screener, an optionally a hindered amine light stabilizer, in an amount sufficient to impart property retention to the spandex after 12 hours exposure to ultraviolet radiation; and spinning the product of c) to form spandex, wherein the optical brightener is selected from the group consisting of an oxazole, a biphenyl, a coumarin, a stilbene, a pyrazolene, a rhodamine, and a fluorescein, or a combination of such members; and the ultraviolet screener is selected from the group consisting of a triazine, a benzotriazole, an oxalanilide, a benzophenone, and a bismalonate, or a combination of such members.

Some embodiments further provide a method for imparting to spandex property retention of elongation at break after 12 hours exposure to ultraviolet radiation, the spandex including an optical brightener and a UV screener. The method includes: a) contacting a polyether glycol selected from the group consisting of polyethyleneether glycol, polytrimethyleneether glycol, poly(tetramethyleneether) glycol, poly(tetramethylene-co-2-methyltetramethyleneether) glycol, poly(tetramethylene-co-ethyleneether) glycol and mixtures thereof, or a polyester glycol selected from the group consisting of reaction products of (i) ethylene glycol, propylene glycol, butylene glycol, 2,2-dimethyl-1,3-propanediol, and mixtures thereof, and (ii) terephthalic acid, succinic acid, adipic acid, azelaic acid, sebacic acid, and dodecanedioic acid, and mixtures thereof, with at least one diisocyanate; b) contacting the reaction product of step a) with at least one chain extender and, optionally, with a chain terminator; c) contacting the reaction product of step b) with an optical brightener and an ultraviolet screener, and optionally a hindered amine light stabilizer, in an amount sufficient to impart property retention of elongation at break to the spandex after 12 hours exposure to ultraviolet radiation; and d) spinning the product of c) to form spandex, wherein the optical brightener is selected from the group consisting of an oxazole, a biphenyl, a coumarin, a stilbene, a pyrazolene, a rhodamine, and a fluorescein, or a combination of such members; and the ultraviolet screener is selected from the group consisting of a triazine, a benzotriazole, an oxalanilide, a benzophenone, and a bismalonate, or a combination of such members.

### DETAILED DESCRIPTION OF THE INVENTION

It has now been found that spandex including an optical brightener and a UV screener has enhanced initial whiteness and improved whiteness retention after environmental exposure to combustion fumes, NO₂ fumes, UV radiation, heat, or chlorine bleach. Furthermore, it has been found that spandex including an optical brightener, an UV screener, and a hindered amine light stabilizer has good property retention after extended exposure to UV radiation. The whiteness of the spandex is measured as CIE whiteness. The enhanced initial whiteness, improved whiteness retention after environmental exposure, and property retention after UV exposure carry through to fabric and garments including the spandex of the invention.

As used herein, the term spandex means a manufactured fiber in which the fiber-forming substance is a long-chain synthetic polymer comprised of at least 85% of a segmented polyurethane. Spandex is also referred to as elastane.

As used herein, “capping ratio” is defined as the molar ratio of diisocyanate to glycol. As used herein, the term “% NCO”, unless otherwise indicated, means the weight percent of the isocyanate end groups in a capped glycol.

As used herein, the term “optical brightener” means an agent which can brighten colors or masks yellowing in substrates such as fiber, paper, paint, and plastic. Optical brighteners absorb UV light and re-emit fluorescent light in the violet-to-blue region of the visible spectrum. This bluing effect can offset a yellowish cast and imparts a brilliant whiteness to the light reflected by the substrate. Optical brighteners are also known as fluorescent whitening agents.

As used herein, the term “UV screener” means a compound which can be added to a substrate, for example a polymeric composition, to protect the substrate from the effects of UV light, for example degradation. Without wishing to be bound by theory, it is believed that the UV screener functions by absorbing UV light and converting it to heat.

As used herein, the term “hindered amine light stabilizer” (HALS) means a sterically hindered amine including a tetramethyl-piperidine structure.

As used herein, the term “delustrant” means a substance that can be used to dull the luster of a manufactured fiber. Incorporating a delustrant into spandex can render the fiber opaque. A typical delustrant used for spandex fiber is titanium dioxide.

As used herein, the term “topical” means a treatment applied locally to the surfaces of the yarn, fabric, or textile article. Topical treatment of yarns, fabrics, or textile articles with optical brighteners can be effective, but not permanent. Topical treatment has the disadvantage, corresponding to an extent to different affinities for different fibers, of being to some extent washed off during subsequent processing or laundering operations.

As used herein, the term “spun-in” refers to material which is added to the polyurethaneurea polymer solution prior to spinning the polymer solution into spandex. Spun-in spandex additives can differ from topically applied spandex finishes in that spun-in additives are typically present throughout the fiber, not just at the fiber surface. Spun-in additives can be typically more difficult to remove from the spandex than topically applied finishes.

As used here, the term “white” is defined as the absence of color and the term “whiteness” means the quality of being white, alternatively stated as the quality of having an absence of color. As used herein, the term “CIE whiteness” means whiteness as measured by AATCC (American Association of Textile Chemists and Colorists) Test Method 110-1994 and as calculated using the formula therein for illuminant D65 and 1976 10° observer. CIE Whiteness is represented as a numerical value; values reported here were rounded to the nearest whole number. The larger the CIE whiteness value of a sample, the greater the whiteness of the sample. An untrained human eye is generally believed to be able to distinguish shades of whiteness which differ by about 15 CIE whiteness units. A trained human eye is generally believed able to differentiate whiteness shades which differ by at least about 3 units.

As used herein, the term “initial whiteness” refers to the whiteness of a material such as spandex in its initial state, that is, before exposure to environmental effects or before additional whitening agents are added in subsequent processing steps, for example in the wet processing of a fabric. Initial whiteness may also be referred to as “as is” whiteness or as “as spun” whiteness.

As used herein, the term “whiteness retention” means the ability of a material to maintain its initial whiteness over time or after environmental exposure. If the CIE whiteness value of a sample after time or environmental exposure is lower than the initial CIE whiteness value, then a decrease in whiteness has occurred. If the CIE whiteness value of a sample is higher than the initial CIE whiteness value, then an increase in whiteness has occurred. Various environmental exposures such as combustion fumes, thermal exposure, NO₂ fumes (a component of smog), UV radiation, and chlorine bleach are known to cause yellowing or discoloration in spandex. As a result, whiteness retention is a desirable quality in spandex and in fabrics including spandex, and improved whiteness retention is also desirable.

In general, the textile and apparel industry seeks the highest whiteness value possible for yarn or fabric. However, the final end-use requirement of the yarn or fabric defines what level of whiteness is acceptable for a particular application. Factors such as the whiteness value of a companion hard yarn or a downstream dyeing step will affect the acceptability of a given whiteness level, and such factors can vary widely with end use. Thus, while there is no universal threshold for useful whiteness, yarn or fabric which has enhanced or improved whiteness is generally desired. In some applications, it may be desirable to adjust the whiteness of yarn or fabric so that the whiteness is sufficient for the desired use, which may be different from the highest CIE whiteness value which can be obtained.

As used herein, the term “companion yarn” means a yarn which is used in conjunction with the spandex, for example during weaving or knitting. As used herein, the term “hard yarn” refers to relatively inelastic yarn, such as polyester, cotton, nylon, rayon, acetate, or wool.

As used herein, the term “textile article” means an article including fabric. “Textile article” includes, for example, a garment or article of clothing such as a shirt, pants, skirt, jacket, coat, work shirt, work pants, uniform, outerwear, sportswear, swimsuit, bra, socks, and underwear, and also includes accessories such as belts, gloves, mittens, hats, hosiery, or footwear. “Textile article” also includes such items as sheets, pillowcases, bedspreads, quilts, blankets, comforters, comforter covers, sleeping bags, shower curtains, curtains, drapes, tablecloths, napkins, wiping cloths, dish towels, and protective coverings for upholstery or furniture.

One embodiment is a spandex having an initial CIE whiteness of at least about 95 as measured by AATCC Test Method 110-1994, the spandex including an optical brightener selected from the group consisting of an oxazole, a biphenyl, a coumarin, a stilbene, a pyrazolene, a rhodamine, and a fluorescein, or a combination of such members; and an ultraviolet screener selected from the group consisting of a triazine, a benzotriazole, an oxalanilide, a benzophenone, and a bismalonate, or a combination of such members.

Another embodiment is spandex wherein the optical brightener is selected from the group consisting of an oxazole, a biphenyl, and a coumarin, or a combination of such members, and wherein the ultraviolet screener is selected from the group consisting of a triazine, a benzotriazole, and an oxalanilide, or a combination of such members.

Another embodiment is spandex wherein the optical brightener is selected from the group consisting of 2,5-thiophenediylbis(5-tert-butyl-1,3-benzoxazole), 4,4′-bis(2-methoxystyryl)-1,1′-biphenyl, 2,2′-(1,2-ethenediyldi-4,1-phenylene)bisbenzoxazole, and 7-(2H-naphtho[1,2-D]triazol-2-yl)-3-phenylcoumarin, or a combination of such members and the ultraviolet screener is selected from the group consisting of 2-(2′-hydroxy-3′,5′-di(1,1-dimethylbenzyl))-2H-benzotriazole, 2-hydroxy-4-n-octyloxybenzophenone, 2-4,6-diphenyl-1,3,5-triazin-2-yl)-5-hexyloxy-phenol, 2-(2′-hydroxy-3′,5′-di-tert-amylphenyl)benzotriazole, 2-ethyl-2′-ethoxy-oxalanilide, 2-(2H-benzotriazol-2-yl)-6-dodecyl-4-methylphenol, and 2-[4,6-bis(2,4-dimethylphenyl)-1,3,5-triazin-2-yl]-5-(octyloxy)phenol, or a combination of such members.

Another embodiment is spandex wherein the optical brightener is 2,5-thiophenediylbis(5-tert-butyl-1,3-benzoxazole) and the ultraviolet screener is 2-[4,6-bis(2,4-dimethylphenyl)-1,3,5-triazin-2-yl]-5-(octyloxy)phenol.

Another embodiment is the spandex of the invention wherein the optical brightener is 4,4′-bis(2-methoxystyryl)-1,1′-biphenyl and the ultraviolet screener is 2-[4,6-bis(2,4-dimethylphenyl)-1,3,5-triazin-2-yl]-5-(octyloxy)phenol.

Another embodiment is spandex including an optical brightener selected from the group consisting of an oxazole, a biphenyl, a coumarin, a stilbene, a pyrazolene, a rhodamine, and a fluorescein, or a combination of such members; and an ultraviolet screener selected from the group consisting of a triazine, a benzotriazole, an oxalanilide, a benzophenone, and a bismalonate, or a combination of such members, in an amount sufficient for the percent growth of the spandex after about 12 hours of exposure to ultraviolet radiation to be less than 16%.

Another embodiment is spandex wherein the percent retention of elongation at break after about 12 hours of exposure to ultraviolet radiation is at least about 60%.

Another embodiment is spandex further including a hindered amine light stabilizer.

Another embodiment is a spandex having an initial CIE whiteness of at least about 95 as measured by AATCC Test Method 110-1994, the spandex including an optical brightener selected from the group consisting of an oxazole, a biphenyl, a coumarin, a stilbene, a pyrazolene, a rhodamine, and a fluorescein, or a combination of such members; and an ultraviolet screener selected from the group consisting of a triazine, a benzotriazole, an oxalanilide, a benzophenone, and a bismalonate, or a combination of such members, wherein after about 4 hours of exposure to ultraviolet radiation, the spandex has a CIE whiteness of at least about 55.

Another embodiment is the spandex having a CIE whiteness of at least about 55 after about 4 hours of exposure to ultraviolet radiation, wherein the optical brightener is selected from the group consisting of 2,5-thiophenediylbis(5-tert-butyl-1,3-benzoxazole), 4,4′-bis(2-methoxystyryl)-1,1′-biphenyl, 2,2′-(1,2-ethenediyldi-4,1-phenylene)bisbenzoxazole, and 7-(2H-naphtho[1,2-D]triazol-2-yl)-3-phenylcoumarin, or a combination of such members and the ultraviolet screener is selected from the group consisting of 2-(2′-hydroxy-3′,5′-di(1,1-dimethylbenzyl))-2H-benzotriazole, 2-hydroxy-4-n-octyloxybenzophenone, 2-4,6-diphenyl-1,3,5-triazin-2-yl)-5-hexyloxy-phenol, 2-(2′-hydroxy-3′,5′-di-tert-amylphenyl)benzotriazole, 2-ethyl-2′-ethoxy-oxalanilide, 2-(2H-benzotriazol-2-yl)-6-dodecyl-4-methylphenol, and 2-[4,6-bis(2,4-dimethylphenyl)-1,3,5-triazin-2-yl]-5-(octyloxy)phenol, or a combination of such members.

Another embodiment is spandex having a CIE whiteness of at least about 55 after about 4 hours of exposure to ultraviolet radiation, wherein the optical brightener is 2,5-thiophenediylbis(5-tert-butyl-1,3-benzoxazole) and the ultraviolet screener is 2-[4,6-bis(2,4-dimethylphenyl)-1,3,5-triazin-2-yl]-5-(octyloxy)phenol.

Another embodiment is spandex having a CIE whiteness of at least about 55 after about 4 hours of exposure to ultraviolet radiation, wherein the optical brightener is 4,4′-bis(2-methoxystyryl)-1,1′-biphenyl and the ultraviolet screener is 2-[4,6-bis(2,4-dimethylphenyl)-1,3,5-triazin-2-yl]-5-(octyloxy)phenol.

Yet another embodiment is fabric including the spandex any embodiment herein.

An additional embodiment is a method for imparting whiteness to spandex; the method including

a) contacting a polyether glycol selected from the group consisting of polyethyleneether glycol, polytrimethyleneether glycol, poly(tetramethyleneether) glycol, poly(tetramethylene-co-2-methyltetramethyleneether) glycol, poly(tetramethylene-co-ethyleneether) glycol and mixtures thereof, or a polyester glycol selected from the group consisting of reaction products of (i) ethylene glycol, propylene glycol, butylene glycol, 2,2-dimethyl-1,3-propanediol, and mixtures thereof, and (ii) terephthalic acid, succinic acid, adipic acid, azelaic acid, sebacic acid, and dodecanedioic acid, and mixtures thereof, with at least one diisocyanate;

b) contacting the reaction product of step a) with at least one chain extender and, optionally, with a chain terminator;

c) contacting the reaction product of step b) with an optical brightener and an ultraviolet screener in an amount sufficient to impart whiteness to the spandex; and

d) spinning the product of c) to form spandex,

wherein the optical brightener is selected from the group consisting of an oxazole, a biphenyl, a coumarin, a stilbene, a pyrazolene, a rhodamine, and a fluorescein, or a combination of such members; and the ultraviolet screener is selected from the group consisting of a triazine, a benzotriazole, an oxalanilide, a benzophenone, and a bismalonate, or a combination of such members.

Another embodiment is a method for adjusting the initial whiteness of spandex to a desired level; the method including

a) contacting a polyether glycol selected from the group consisting of polyethyleneether glycol, polytrimethyleneether glycol, poly(tetramethyleneether) glycol, poly(tetramethylene-co-2-methyletetramethyleneether) glycol, poly(tetramethylene-co-ethyleneether) glycol, and mixtures thereof with, or a polyester glycol selected from the group consisting of reaction products of (i) ethylene glycol, propylene glycol, butylene glycol, 2,2-dimethyl-1,3-propanediol, and mixtures thereof, and (ii) terephthalic acid, succinic acid, adipic acid, azelaic acid, sebacic acid, and dodecanedioic acid, and mixtures thereof, with at least one diisocyanate;

b) contacting the reaction product of step a) with at least one chain extender and, optionally, with a chain terminator;

c) contacting the reaction product of b) with an optical brightener and an ultraviolet screener in an amount sufficient to provide the desired initial whiteness level to spandex; and

d) spinning the product of step c) to form spandex having the desired whiteness,

wherein the optical brightener is selected from the group consisting of an oxazole, a biphenyl, a coumarin, a stilbene, a pyrazolene, a rhodamine, and a fluorescein, or a combination of such members; and the ultraviolet screener is selected from the group consisting of a triazine, a benzotriazole, an oxalanilide, a benzophenone, and a bismalonate, or a combination of such members.

Another embodiment is a method for imparting whiteness retention after scouring or after environmental exposure to combustion fumes, nitrogen dioxide fumes, ultraviolet radiation, heat, or chlorine bleach to spandex, the method including

a) contacting a polyether glycol selected from the group consisting of polyethyleneether glycol, polytrimethyleneether glycol, poly(tetramethyleneether) glycol, poly(tetramethylene-co-2-methyltetramethyleneether) glycol, poly(tetramethylene-co-ethyleneether) glycol, and mixtures thereof, or a polyester glycol selected from the group consisting of reaction products of (i) ethylene glycol, propylene glycol, butylene glycol, 2,2-dimethyl-1,3-propanediol, and mixtures thereof, and (ii) terephthalic acid, succinic acid, adipic acid, azelaic acid, sebacic acid, and dodecanedioic acid, and mixtures thereof, with at least one diisocyanate;

b) contacting the reaction product of step a) with at least one chain extender and, optionally, with a chain terminator;

c) contacting the reaction product of b) with an optical brightener and an ultraviolet screener in an amount sufficient to provide whiteness retention to the spandex after scouring or after environmental exposure; and

d) spinning the product of step c) to form spandex,

wherein the optical brightener is selected from the group consisting of an oxazole, a biphenyl, a coumarin, a stilbene, a pyrazolene, a rhodamine, and a fluorescein, or a combination of such members; and the ultraviolet screener is selected from the group consisting of a triazine, a benzotriazole, an oxalanilide, a benzophenone, and a bismalonate, or a combination of such members.

Another embodiment is a method for imparting to spandex property retention of tenacity at break or elongation at break after 12 hours exposure to UV radiation, the method including:

a) contacting a polyether glycol selected from the group consisting of polyethyleneether glycol, polytrimethyleneether glycol, poly(tetramethyleneether) glycol, poly(tetramethylene-co-2-methyltetramethyleneether) glycol, poly(tetramethylene-co-ethyleneether) glycol, and mixtures thereof, or a polyester glycol selected from the group consisting of reaction products of (i) ethylene glycol, propylene glycol, butylene glycol, 2,2-dimethyl-1,3-propanediol, and mixtures thereof, and (ii) terephthalic acid, succinic acid, adipic acid, azelaic acid, sebacic acid, and dodecanedioic acid, and mixtures thereof, with at least one diisocyanate;

b) contacting the reaction product of step a) with at least one chain extender and, optionally, with a chain terminator;

c) contacting the reaction product of b) with an optical brightener, an ultraviolet screener, and optionally a hindered amine light stabilizer, in an amount sufficient to impart property retention to the spandex after extended exposure to ultraviolet radiation; and

d) spinning the product of step c) to form spandex,

wherein the optical brightener is selected from the group consisting of an oxazole, a biphenyl, a coumarin, a stilbene, a pyrazolene, a rhodamine, and a fluorescein, or a combination of such members; and the ultraviolet screener is selected from the group consisting of a triazine, a benzotriazole, an oxalanilide, a benzophenone, and a bismalonate, or a combination of such members.

Yet another embodiment is a fabric including at least one weight percent spandex, the spandex including an optical brightener selected from the group consisting of an oxazole, a biphenyl, a coumarin, a stilbene, a pyrazolene, a rhodamine, and a fluorescein, or a combination of such members; and an ultraviolet screener selected from the group consisting of a triazine, a benzotriazole, an oxalanilide, a benzophenone, and a bismalonate, or a combination of such members, wherein the fabric has whiteness retention greater than that of a comparison fabric made in the same way but with spandex lacking an optical brightener and a UV screener.

Yet another embodiment is a garment or textile article including the fabric of any embodiment described herein.

Another embodiment is a spandex including an optical brightener and a specific antioxidant, in the absence of adding a UV screener. In this embodiment, the optical brightener may be any described herein. The antioxidant is selected from those including at least one unsymmetrically di-hindered hydroxyphenyl group. “Unsymmetrically di-hindered hydroxyphenyl” means an hydroxyphenyl group which has two different alkyl groups at the two ring positions adjacent to the hydroxyl group. Examples of antioxidants including an unsymmetrically di-hindered hydroxyphenyl group include 1,3,5-tris(2,6-dimethyl-3-hydroxy-4-t-butylbenzyl) isocyanurate, in which the unsymmetrically di-hindered hydroxyphenyl groups are covalently bound to an isocyanurate backbone, and ethylene-1,2-bis(oxyethylene)bis[3-(5-t-butyl-4-hydroxy-m-tolyl)propionate], in which the unsymmetrically di-hindered hydroxyphenyl groups are covalently bound to a bisester backbone. These are available as Cyanox® 1790 (Cytec Industries) and Irganox® 245 (Ciba Specialty Chemicals Corporation), respectively.

The spandex compositions that exclude the UV screener are especially useful for achieving and retaining a desired whiteness where the composition will not have excessive exposure to UV radiation. For example, fibers, fabrics, and garments including this spandex composition are particularly useful for undergarments and other intimate apparel.

Polyurethaneureas useful for making spandex are customarily prepared by reacting (“capping”) a difunctional polyether-based glycol or a polyester-based glycol with a diisocyanate to form an isocyanate-capped prepolymer (“capped glycol”). The capped glycol is then dissolved in a suitable solvent to provide a homogeneous polymer solution containing little or no gels and reacted with a diamine difunctional chain extender. Optionally, a chain terminator, for example diethylamine, cyclohexylamine, or n-hexylamine, can be used to control the molecular weight of the polymer, and a trifunctional “chain brancher” such as diethylenetriamine can be used to control solution viscosity. Optionally, catalysts such as dibutyltin dilaurate, stannous octoate, mineral acids, tertiary amines such as triethylamine, N,N′-dimethylpiperazine and other known catalysts can be used to assist in the capping step. Suitable solvents include, for example, N,N-dimethylacetamide (DMAc), N-methylpyrrolidinone (NMP), N,N-dimethylformamide (DMF) and dimethyl sulfoxide (DMSO).

Useful polyether glycols include, but are not limited to, polyethyleneether glycol, polytrimethyleneether glycol, poly(tetramethyleneether) glycol (also known as PTMEG), poly(tetramethylene-co-2-methyltetramethyleneether) glycol, poly(tetramethylene-co-ethyleneether) glycol, and mixtures thereof. The polyether glycols suitable for use in the present invention have number average molecular weights of about 600 to about 4000, for example about 1000 to about 3500, or about 1600 to about 2500, or about 1800 to about 2000. TERATHANE® 1800 (available from Invista S. à r. l.) is an exemplary poly(tetramethyleneether) glycol.

Useful polyester glycols for making polyester-based spandex include, but are not limited to, reaction products of (i) glycols, such as, for example, ethylene glycol, propylene glycol, butylene glycol, 2,2-dimethyl-1,3-propane diol, and mixtures thereof, and (ii) diacids, such as terephthalic acid, succinic acid, adipic acid, azelaic acid, sebacic acid, and dodecanedioic acid, and mixtures thereof. Copolymers are also suitable. Also suited for use in making the polymers are polyetherester glycols comprised of portions of the above-described polyethers and polyesters, and diol-terminated polycarbonates such as poly(pentane-1,5-carbonate) diol and poly(hexane-1,6-carbonate) diol.

Useful diisocyanates include, but are not limited to, 1-isocyanato-4-[(4-isocyanatophenyl)methyl]benzene, (“4,4′-MDI”) 1-isocyanato-2-[(4-cyanatophenyl)methyl]benzene (“2,4′-MDI”), mixtures of 4,4′-MDI and 2,4′-MDI, bis(4-isocyanatocyclohexyl) methane, 5-isocyanato-1-(isocyanatomethyl)-1,3,3-trimethylcyclohexane, 1,3-diisocyanato-4-methyl-benzene, 2,2′-toluenediisocyanate, 2,4′-toluenediisocyanate and mixtures thereof.

Useful chain extenders include ethylene diamine, 1,3-butanediamine, 1,4-butanediamine, 1,3-diamino-2,2-dimethylbutane, 1,6-hexanediamine, 1,2-propanediamine, 1,3-propanediamine, N-methylaminobis(3-propylamine), 2-methyl-1,5-pentanediamine (MPMD, commercially available as DYTEK® A from Invista S. à r. l.), 1,5-diaminopentane, 1,4-cyclohexanediamine, 1,3-diamino-4-methylcyclohexane, 1,3-cyclohexane-diamine, 1,1-methylene-bis(4,4′-diaminohexane), 3-aminomethyl-3,5,5-trimethylcyclohexane, 1,3-diaminopentane, m-xylylene diamine, piperazine, cyclohexylene-1,3-diamine (hydrogenated m-phenylene diamine), isophorone diamine, 1,4-diamino-2-methylpiperazine, 1,4-diamino-2,5-dimethylpiperazine, and methyl bispropylamine; and mixtures thereof.

Spandex can be formed from the polyurethaneurea polymer solution through fiber spinning processes such as wet or dry spinning. In dry spinning, the polymer solution is metered through spinneret orifices into a spin chamber to form a filament or filaments. Typically, the polyurethaneurea polymer is dry spun into filaments from the same solvent as was used for the polymerization reactions. Gas is passed through the chamber to evaporate the solvent to solidify the filament(s). The spandex can be spun as single filaments or can be coalesced by conventional techniques into multi-filament yarns. Each filament is of textile decitex, in the range of 6 to 25 dtex per filament. Lubricant can be deposited on the surface of the filaments by a conventional finish roll or by being co-spun with the filament from the polymer solution, or by both methods. The dry-spun spandex is then wound up to form a yarn supply package.

Delustrants such as titanium dioxide can be added to spandex to dull the appearance of the fiber. Titanium dioxide can be added, for example, at about 0.2 weight percent to about 5 weight percent, based on polyurethaneurea. Other delustrants may be used at similar concentrations. In addition to dulling the fiber's appearance, delustrants may also impart a white color to the spandex if used at high enough concentration.

Delustrants can typically provide lower CIE whiteness values to spandex than can optical brighteners; however, it has now been found that titanium dioxide in combination with an optical brightener can provide enhanced whiteness to the spandex which can significantly exceed that obtained with an optical brightener or titanium dioxide alone. This is surprising because it is generally known that titanium dioxide reduces the effectiveness of optical brighteners. For example, the publication “Optical Brighteners,” available from Ciba Specialty Chemicals, notes that “the effectiveness of a fluorescent whitener is dependent upon the type of substrate, processing conditions, and possible interactions with other components in the formulation such as white pigments or UV absorbers.” The publication discloses that “anatase type titanium dioxide pigments absorb approximately 40% of the incident radiation at 380 nm, while rutile type titanium dioxide pigments absorb about 90%.” Surprisingly, however, applicants have found that even at high titanium dioxide levels, high CIE whiteness of the spandex can be maintained when an optical brightener is used.

The spandex can also comprise conventional additives such as anti-tack agents, antioxidants, antimicrobials, flameproofing agents, lubricants, and dyestuffs, for example, as long as they do not detract from the benefits of the invention.

A variety of optical brighteners can be used in an amount sufficient to impart the desired level of whiteness to the spandex. For example, an oxazole optical brightener such as 2,5-thiophenediylbis(5-tert-butyl-1,3-benzoxazole), which is available under the trade name Uvitex® OB from Ciba Specialty Chemicals, can be used at about 0.01 weight percent to about 5 weight percent, based on yarn weight. 2,2′-(1,2-Ethenediyldi-4,1-phenylene)bisbenzoxazole, available under the trade name Eastobrite® OB-1 from Eastman Chemical Company, is another example of an oxazole optical brightener and can be used in spandex at a level of about 0.004 weight percent to about 0.05 weight percent, based on yarn weight. A biphenyl optical brightener such as 4,4′-bis(2-methoxystyryl)-1,1′-biphenyl, available under the trade name Uvitex® FP from Ciba Specialty Chemicals, can be used at a level of about 0.01 weight percent to about 0.5 weight percent in spandex, based on yarn weight. Alternatively, a coumarin optical brightener such as 7-(2H-naphtho[1,2-D]triazol-2-yl)-3-phenylcoumarin, available under the trade name Leucopure®) EGM from Clariant Corporation, can be used at a level of about 0.01 to about 0.1 weight percent in spandex, based on yarn weight. Optical brighteners from other chemical classes can also be used, for example, stilbenes, pyrazolenes, rhodamines, and fluoresceins. The optimal amount of a particular optical brightener is that which is sufficient to impart the desired level of CIE whiteness to the spandex and is determined largely by the solubility range of the optical brightener in the solvent used to prepare the spandex. Suboptimal amounts can provide inferior whitening of the spandex, although when the desired outcome is improved spandex whiteness rather than maximum whiteness, relatively low concentrations of optical brightener may be used, for example amounts below about 0.1 weight percent. The use of excessive amounts of optical brightener can result in colored spandex as well as increased manufacturing cost.

A variety of organic UV screeners can be added to spandex in an amount sufficient, together with the optical brightener, to impart protection against the negative effects of UV radiation. Examples of negative effects of UV radiation can include yellowing and property loss, for example decreased tenacity at break or elongation at break. Organic UV screeners are often themselves highly colored materials and may impart undesired color to the spandex if used at too high a concentration. Triazine UV screeners include 2-[4,6-bis(2,4-dimethylphenyl)-1,3,5-triazin-2-yl]-5-(octyloxy)phenol (available under the tradename Cyasorb®) UV-1164 from Cytec) and 2-4,6-diphenyl-1,3,5-triazin-2-yl)-5-hexyloxy-phenol (available under the trade name Tinuvin® 1577 from Ciba Specialty Chemicals). Alternatively, benzotriazole UV screeners such as 2-(2′-hydroxy-3′,5′-di(1,1-dimethylbenzyl))-2H-benzotriazole (available from Ciba Specialty Chemicals under the tradename Tinuvin®) 234, or from Great Lakes under the tradename Lowilite® 234), 2-(2′-hydroxy-3′,5′-di-tert-butylphenyl)-5-chlorobenzotriazole (available from Ciba Specialty Chemicals under the tradename Tinuvin® 327, or from Great Lakes as Lowilite® 27), 2-(2′-hydroxy-3′,5′-di-tert-amylphenyl)benzotriazole (available from Ciba Specialty Chemicals under the tradename Tinuvin®) 328, or from Great Lakes under the tradename Lowilite® 28), and branched and linear 2-(2H-benzotriazol-2-yl)-6-dodecyl-4-methylphenol, (available from Ciba Chemicals under the tradename Tinuvin® 571) can be used. UV Screeners from other chemical classes can also be used and include oxalanilides, such as 2-ethyl-2′-ethoxy-oxalanilide (available from Clariant under the tradename Sanduvor® VSU), benzophenones, for example 2-hydroxy-4-n-octyloxybenzophenone (available from Clariant under the tradename Hostavin® ARO 8), bismalonates, which include for example tetraethyl-2,2′-(1,4-phenylenedimethylidyne)bismalonate (available from Clariant under the tradename Hostavin® B-CAP), and benzylidene malonates, such as dimethyl-p-methoxybenzylidenemalonate (available from Clariant under the tradename Hostavin®) PR-25).

Natural fibers generally absorb more light in the blue region of the visible spectrum than in other regions due to the natural pigments they contain. This phenomenon can give natural fibers an undesirable yellowish cast. Synthetic fibers can also have this yellowish cast, though not as pronounced as for natural fibers. An optical brightener can provide whiteness by absorbing UV radiation and re-emitting fluorescent violet-to-blue light. This added violet-to-blue light can offset the yellowish cast, resulting in a perceived increase in whiteness.

It was unexpected that an optical brightener in combination with an organic UV screener would provide enhanced whiteness to spandex. Organic UV screeners absorb light in the same UV wavelength range as optical brighteners, thus the combination of an optical brightener and an organic UV screener was expected to result in reduced effectiveness of the optical brightener and reduced whiteness of the spandex. Surprisingly, however, in spandex the combination of an optical brightener and an organic UV screener was found to impart high initial whiteness. The combination in spandex of an optical brightener and an organic UV screener was also found to provide enhanced whiteness that is durable to wet processing (for example, scouring). The enhanced whiteness is also maintained after exposure to various environmental effects which are known to cause yellowing or discoloration in spandex, such as combustion fumes, thermal exposure, NO₂ fumes, UV radiation, and chlorine bleach. The combination in spandex of an optical brightener and an organic UV screener provides improved property retention after UV exposure for tenacity at break and elongation at break as compared to that for spandex including only an optical brightener.

The optical brightener and the UV screener, or alternatively the antioxidant, can be added together or separately at any stage of production in a manner which permits addition of controlled amounts. For example, the optical brightener and the UV screener may be added to the polyurethaneurea polymer solution from which the spandex is spun. When added in this way, the additives are said to be “spun-in”. Alternatively, if desired, the optical brightener or the UV screener, or both, can be applied topically to the spandex as a spin finish. Topical application is generally less desirable because an additive can be more easily removed from the spandex when it is topically applied. The optical brightener can be added in an amount sufficient to impart the desired level of whiteness to the spandex. Typically, the amount of optical brightener in the spandex ranges from about 0.004 weight percent to about 5 weight percent, based on weight of spandex, and is determined by its solubility in the solvent used for spinning the spandex, for example DMAc. The UV screener is added in an amount such that the combination of optical brightener and UV screener is sufficient to impart the desired level of whiteness, whiteness retention, and property retention to the spandex. Typically, the amount of UV screener in the spandex ranges from about 0.004 weight percent to about 2 weight percent, based on weight of spandex.

Optionally a sterically hindered amine, also known as a hindered amine light stabilizer or HALS, may be added to any of the spandex compositions. The sterically hindered amine may be basic or relatively non-basic, and it may be derivatized at the nitrogen as in the case of an N-acyl, N-alkyl, N-hydroxy, or N-alkoxy amine. The use of sterically hindered amines as an additive for a variety of polymers, including spandex, is well known in the art. Examples of hindered amine light stabilizers which may be used include the following compounds: N-acetyl-3-dodecyl-1-(2,2,6,6-tetramethyl-4-piperidinyl)2,5-pyrrolidinedione, bis(2,2,6,6-tetramethyl-4-piperidyl) sebacate, poly([(6-morpholino-s-triazine-2,4-diyl)[2,2,6,6-tetramethyl-4-piperidyl)imino]-hexamethylene [(2,2,6,6-tetramethyl-4-piperidyl)imino]], bis(2,2,6,6-tetramethylpiperidin-4-yl)succinate, bis(1-octyloxy-2,2,6,6-tetramethylpiperidin-4-yl)sebacate, 4-benzoyl-2,2,6,6-tetramethylpiperidine, and 4-stearyloxy-2,2,6,6-tetramethylpiperidine.

The positive effect of an optical brightener and an UV screener (or alternatively, the antioxidant) on the initial whiteness and whiteness retention after environmental exposure of spandex is believed generally applicable to all spandex which comprises a polyether-based glycol or a polyester-based glycol. Enhanced initial whiteness, improved whiteness retention, and property retention after extended exposure to UV radiation are due to the use of a sufficient amount of an optical brightener and a UV screener, optionally in conjunction with a hindered amine light stabilizer, and do not depend on use of a specific diisocyanate or glycol in the manufacture of the spandex.

Several useful purposes can be served by adding an optical brightener and an ultraviolet screener (or alternatively, the antioxidant), and optionally a hindered amine light stabilizer, to the spandex. Use of a sufficient amount of an optical brightener and an ultraviolet screener can provide a method for imparting whiteness to spandex, or a method for adjusting the initial whiteness of spandex to a desired level, as when the maximum possible whiteness is not required or desired but an improvement from a lower CIE whiteness value is sufficient for the particular use. Use of a sufficient amount of an optical brightener and a UV screener can provide a method for imparting whiteness retention after scouring or after environmental exposure to combustion fumes, nitrogen dioxide fumes, UV radiation, heat, or chlorine bleach to spandex. Use of a sufficient amount of an optical brightener and a UV screener, and optionally a hindered amine light stabilizer, can provide a method for imparting property retention of tenacity at break or elongation at break to spandex after extended exposure to UV radiation. For each purpose described above, the method comprises

a) contacting a polyether glycol selected from the group consisting of polyethyleneether glycol, polytrimethyleneether glycol, poly(tetramethyleneether) glycol, poly(tetramethylene-co-2-methyltetramethyleneether) glycol, poly(tetramethylene-co-ethyleneether) glycol, and mixtures thereof, or a polyester glycol selected from the group consisting of reaction products of (i) ethylene glycol, propylene glycol, butylene glycol, 2,2-dimethyl-1,3-propanediol, and mixtures thereof, and (ii) terephthalic acid, succinic acid, adipic acid, azelaic acid, sebacic acid, and dodecanedioic acid, and mixtures thereof, with at least one diisocyanate;

b) contacting the reaction product of step a) with at least one chain extender and, optionally, with a chain terminator;

c) contacting the reaction product of c) with an optical brightener, an ultraviolet screener, and optionally a hindered amine light stabilizer, in an amount sufficient to impart the desired characteristic to the spandex; and

d) spinning the product of step c) to form spandex.

Knit and woven stretch fabrics can be made from spandex of any embodiment. Stretch fabric examples include circular, flat, and warp knits, and plain, twill, and satin wovens. The high initial whiteness, whiteness retention, and stretch characteristics of the spandex are typically carried through to the fabric as enhanced whiteness, enhanced whiteness retention, and high stretch and recovery, which are highly desirable for apparel. Garments such as pants, shirts, sportswear, uniforms, socks, underwear, outer wear, jackets, mittens, gloves, and hats can be made from the stretch fabrics including the spandex of the invention.

Fabrics including the spandex of any embodiment herein may also comprise at least one fiber selected from the group consisting of protein, cellulosic, and synthetic polymer fibers, or a combination of such members. As used herein, “protein fiber” means a fiber composed of protein, including such naturally occurring animal fibers as wool, silk, mohair, cashmere, alpaca, angora, vicuna, camel, and other hair and fur fibers. As used herein, “cellulosic fiber” means a fiber produced from tree or plant materials, including for example cotton, rayon, acetate, lyocell, linen, ramie, and other vegetable fibers. As used herein, “synthetic polymer fiber” means a manufactured fiber produced from a polymer built up from chemical elements or compounds, including for example polyester, polyamide, acrylic, spandex, polyolefin, and aramid. The enhanced whiteness and whiteness retention of the spandex are imparted to the fabric including the spandex, even when the spandex is combined with a companion yarn.

Fabrics including spandex may have a spandex content of about 0.5 weight percent (wt %) to about 40 wt %, based on weight of the fabric. For example, woven fabrics including spandex may contain from about 0.5 wt % to about 4 wt % spandex, circular knits including spandex may contain from about 2 wt % to about 25 wt % spandex, legwear including spandex may contain from about 1 wt % to about 40 wt % spandex, raschel fabric including spandex may contain from about 10 wt % to about 40 wt % spandex, and warp knit tricots including spandex may contain from about 14 wt % to about 22 wt % spandex.

While the actual whiteness of the fabric is dependent on such factors as fabric construction, fabric dyeing and finishing conditions such as scouring processes, bleaching processes, and any topical whitening after-treatments that may be applied, such fabric can have an enhanced initial whiteness when compared to fabric which differs only in that the spandex lacks optical brightener, or optical brightener in combination with an UV screener. The initial fabric whiteness is related to the spandex content of the given fabric and increases as the weight percent spandex increases. The enhanced initial whiteness can be obtained prior to any subsequent application of a topical optical brightener through additional wet processing steps, and can be maintained through scouring or repeated washing of the fabric.

When dyed in pale to medium pastel or bright colors, fabric including spandex which includes an optical brightener and an organic UV screener (or the antioxidant) can provide a brighter, truer color without the influence of the yellow base normally observed with spandex. For example, such fabric dyed a pink shade can have color which is measurably redder and bluer than fabric dyed similarly but including a spandex of lower CIE whiteness.

Analytical Methods

Percent isocyanate (% NCO) of the capped glycols was determined according to the method of S. Siggia, “Quantitative Organic Analysis via Functional Group”, 3rd Edition, Wiley & Sons, New York, pages 559-561 (1963) using a potentiometric titration.

The strength and elastic properties of the spandex were measured in accordance with the general method of ASTM D 2731-72. Three filaments, a 2-inch (5-cm) gauge length and zero-to-300% elongation cycles were used for each of the measurements “as-is” from the windup, that is, without scouring or other treatment, after 24 hours of aging at approximately 70° F. and 65% relative humidity (+/−2%) in a controlled environment. The samples were cycled five times at a constant elongation rate of 50 cm per minute and then held at 300% extension for 30 seconds after the fifth extension. Percent elongation at break and percent tenacity at break were measured on the sixth extension cycle using modified Instron grips to which a rubber tape was attached for reduced slippage.

CIE Whiteness was determined according to AATCC Test Method 110-1994, “Whiteness of Textiles”. CIE Whiteness values were rounded to the nearest whole number for reporting. Measurements were made on wound cards with a Datacolor Spectraflash Model SF-300 calorimeter (Datacolor International, Lawrenceville, N.J.) using a D65/10 degree illuminant. CIE Whiteness values reported below for the as-spun and scoured/mocked dyed samples were typically the average of all 15 of the cards wound for each sample. CIE Whiteness values reported for fume, thermal, UV, NO₂ fumes, and chlorine bleach exposures were the average of the three cards used for each type of exposure.

Spandex fiber whiteness and whiteness retention were assessed by determining the amount of discoloration produced upon exposure of the fiber to heat, ultraviolet light, combustion fumes, NO₂ fumes, or chlorine bleach. In preparation for determining the effect of these environmental factors on the spandex, the fiber was wound under low tension on 8 cm×11 cm×0.2 cm aluminum cards to form a layer 3-4 millimeters thick. The wound cards were immersed in water containing 1.5 g/l of Supralate® EP (a sulfate detergent sold by Witco Corp.) and 1.5 g/l of sodium pyrophosphate, and the bath was heated to boiling for 30 minutes (scour). The cards were then rinsed with deionized water and allowed to air dry overnight. Spandex samples which were evaluated for whiteness retention after 4 hours of UV exposure were scoured before UV exposure. Spandex samples which were evaluated after 12 hours of UV exposure were not scoured before UV exposure.

Thermal degradation tests (labeled “thermal” in the table below) were performed in an oven in which the samples were exposed to air at 160° C., typically in 15 minute increments, for the total time indicated. For exposure to ultraviolet light (labeled “UV” in the table below), tests were conducted in an Atlas Series C “Weather-ometer”, made by Atlas Electric Devices Co. of Chicago, III. In the Weather-ometer, samples are exposed for the time indicated to a 6000 watt xenon lamp having a spectrum resembling that of sunlight and providing irradiance in both the visible and ultraviolet regions. The xenon lamp is used with a borosilicate filter which has a cut off at 280 nm. Tests in which samples were exposed to combustion fumes (labeled “fume” in the table below) were conducted similarly to Test Method 23-1994 of AATCC (American Association of Textile Chemists and Colorists) using a Model 8727 atmospheric fume chamber made by United States Testing Company, Inc. The chamber was supplied with combustion fumes generated by burning propane (Air Gas, Inc.) with a Bunsen burner adjusted to give a predominantly blue flame. The flame height was such that the temperature in the chamber was kept between 57 and 63° C. Sample exposure duration was in increments of 12 hours per cycle. For exposure to NO₂ gas alone (labeled “NO₂” in the tables below), an Atlas Gas Exposure chamber, made by Atlas Electric Devices Co. of Chicago, Ill., was used. The temperature and relative humidity were allowed to remain at or near room conditions and samples were exposed typically for 12 hours per cycle until the CIE whiteness of the control (the sample without optical brightener or UV screener) was reduced to the 40-60 CIE range. The chamber was supplied with air containing approximately 1000 ppm of NO₂ at a rate of approximately 3 liters/minutes.

For the chlorine bleach test (labeled “chlorine” in the table), wound cards were immersed for 5 hours at room temperature in an unstirred bath containing 4 grams of Clorox bleach per 1000 grams of deionized water. After exposure, the samples were rinsed with deionized water and allowed to air dry overnight before making whiteness measurements.

Percent growth after extended UV exposure was determined according to the following method. Three to six filament samples of yarn were mounted onto a frame set to 10.0 cm and having double sided tape at both ends. The filaments were draped from end to end until just barely taut but without tension. Small springs or clips were used to enable more uniform tension from sample to sample. The ends of the samples were then secured with single sided tape. Sample holder clamps were then applied at the ends of the samples, adjacent to and inside the tape, so that the filaments were secured by the clamps. The frame was then stretched to 15 cm, which stretched the yarn samples 1.5× of their original length. The frame with its yarn samples was then placed into the Weather-ometer described previously and exposed to a xenon light having a spectrum resembling that of sunlight for the desired time. The frame with its yarn samples was then removed from the Weather-ometer, the frame was relaxed to its original length, and the frame and yarn samples were allowed to cool. The new sample lengths were then measured with a ruler or with calipers by stretching the frame out until the shortest sample was fully extended but without tension. The new sample length was measured and recorded to the nearest tenth of a centimeter (RL). This process was repeated for each successively longer yarn sample. Values for multiple ends were averaged. Percent UV growth was calculated according to the following formula:
% UV Growth=((RL−10)/10)×100

Some spandex samples were also evaluated for property retention after extended UV exposure. After the percent growth determinations were made, tenacity at break and elongation at break were determined according to the method described above, but using yarn that had undergone UV exposure. Property retention is reported as compared to data for the same sample before UV exposure. For example, the percent retention of the tenacity at break property is given as the tenacity at break after UV exposure divided by the tenacity at break before UV exposure, taken as a percentage. The percent retention of the elongation at break property is given as the tenacity at break after UV exposure divided by the tenacity at break before UV exposure, taken as a percentage.

The features and advantages of the present invention are more fully shown by the following examples which are provided for purposes of illustration, and are not to be construed as limiting the invention in any way.

### EXAMPLES

The following Examples demonstrate the present invention and its capability for use. The invention is capable of other and different embodiments, and its several details are capable of modifications in various apparent respects, without departing from the scope and spirit of the present invention. Accordingly, the Examples are to be regarded as illustrative in nature and not as restrictive.

The diisocyanate used in the Examples was obtained from Dow Chemical. The polyether glycol used in the Examples was TERATHANE® 1800 (Invista S. à r. l.) a polytetramethyleneether glycol having a number average molecular weight of 1800.

The optical brighteners used in the Examples were as indicated in Table 1 and were obtained from the listed supplier. The UV screeners used in the Examples were as indicated in Table 2.

Optical brighteners used in the Examples, their chemical names, and examples of their tradenames and suppliers are given in the following Table. UV Screeners, including those used in the Examples, their chemical names, and examples of their trade names and suppliers are given in Table 2.

TABLE 1

| Chemical Name of Optical | Trademark | |
|---|---|---|
| Brightener | Name | Supplier |
| 2,5-thiophenediylbis(5-tert- | Uvitex ® OB | Ciba Specialty |
| butyl-1,3-benzoxazole) | | Chemicals |
| 4,4′-bis(2-methoxystyryl)- | Uvitex ® FP | Ciba Specialty |
| 1,1′-biphenyl | | Chemicals |
| 2,2′-(1,2-Ethenediyldi-4,1- | Eastobrite ® | Eastman |
| phenylene)bisbenzoxazole | OB-1 | Chemical |
| 7-(2H-naphtho[1,2-D]triazol- | Leucopure ® | Clariant |
| 2-yl)-3-phenylcoumarin | EGM | |

TABLE 2

| | Trademark | |
|---|---|---|
| Chemical Name of UV Screener | Name | Supplier |
| 2-[4,6-bis(2,4-dimethylphenyl)- | Cyasorb ® | Cytec |
| 1,3,5-triazin-2-yl]-5- | UV-1164 * | |
| (octyloxy)phenol | | |
| 2-4,6-diphenyl-1,3,5-triazin-2- | Tinuvin ® | Ciba Specialty |
| yl)-5-hexyloxy-phenol | 1577 * | Chemicals |
| 2-(2′-hydroxy-3′,5′- | Tinuvin ® | Ciba Specialty |
| di(1,1-dimethylbenzyl))- | 234 | Chemicals |
| 2H-benzotriazole | Lowilite ® | Great Lakes |
| | 234 * | |
| 2-(2′-hydroxy-3′,5′- | Tinuvin ® | Ciba Specialty |
| di-tert-butylphenyl)-5- | 327 | Chemicals |
| chlorobenzotriazole | Lowilite ® | Great Lakes |
| | 27 | |
| | Cyasorb ® | Cytec |
| | 5357 | |
| 2-(2′-hydroxy-3′.5′-di- | Tinuvin ® | Ciba Specialty |
| tert-amylphenyl)benzotriazole | 328 | Chemicals |
| | Lowilite ® | Great Lakes |
| | 28 * | |
| | Cyasorb ® | Cytec |
| | 2337 | |
| 2-(2H-benzotriazol-2-yl)-6- | Tinuvin ® | Ciba Specialty |
| dodecyl-4-methylphenol | 571 * | Chemicals |
| 2-ethyl-2′-ethoxy-oxalanilide | Saduvor ® | Clariant |
| | VSU * | |
| 2-hydroxy-4-n- | Hostavin ® | Clariant |
| octyloxybenzophenone | ARO [symbol] | |
| | Cyasorb ® | Cytec |
| | 531 | |
| | Lowilite ® | Great Lakes |
| | 22 | |
| | Chimassorb ® | Ciba Specialty |
| | 81 | Chemicals |
| tetraethyl 2,2′-(1,4- | Hostavin ® | Clariant |
| phenylenedimethylidyne)bismalonate | B-CAP | |
| Dimethyl-p- | Hostavin ® | Clariant |
| methoxybenzylidenemalonate | PR-25 | |

Note:
An asterisk (*) indicates the material used in the Examples.

In the Tables, “Comp. Ex.” means Comparison Example, “Opt. B.” means optical brightener, “h” means hours, “min” means minutes, “sec” means seconds, “-” means not present, “NM” means not measured, “ELO” means elongation at break, “TEN” means tenacity at break, and “ret” means retention.

### Preparation of Comparison Example 6A, Comparison Example 7A, Comparison Example 7B, and Comparison Example 7C

The polyurethaneurea polymers and spandex of Comparison Example 6A, Comparison Example 7A, Comparison Example 7B, and Comparison Example 7C were prepared according to the following general method. A polyurethanurea was first prepared by reacting at approximately 90° C. for 2 hours a poly(tetramethylene ether) glycol of number average molecular weight of about 1800 with 4,4′-diphenylmethane diisocyanate at a diisocyanate to glycol molar ratio of about 1.69 to 1.0. The resulting capped glycol mixture contained isocyanate terminated polymeric glycol and residual unreacted diisocyanate. The capped glycol was then completely dissolved in DMAc at about 45° C. under high shear. The capped glycol solution was contacted, under high shear, with a DMAc solution containing a mixture of ethylene diamine, 2-methylpentamethylene diamine (in a 90/10 molar ratio), diethylamine, and additional DMAc.

An additive slurry was prepared by mixing together Cyanoxe 1790 (1,3,5-tris(4-t-butyl-3-hydroxy-2,6-dimethyl-benzyl)-1,3,5-triazine-2,4,6-(1H,3H,5H)trione, available from Cytec Industries), a polymer of bis(4-isocyanatocyclohexyl)methane and 3-t-butyl-3-aza-1,5-pentanediol (Methacrol® 2462B, a registered trademark of and available from E.I. DuPont de Nemours and Company), silicone oil and a dilute solution of the polyurethaneurea polymer in DMAc. To form spinning solutions, the additive slurry was mixed into the polymer solution so that the final spandex contained 1.5 wt % Cyanox® 1790, 0.5 wt % Methacrol® 2462B, and 0.6 wt % silicone oil.

Additional additives as indicated in the Tables were also mixed into the polymer solution, either as a neat liquid or as a dispersion or solution of solids in DMAc, in quantities sufficient to give the indicated concentrations in the final spandex. For inorganic particulate additives, dispersions of the additives in DMAc were media milled in order to deagglomerate the solids and reduce the particle size to an acceptable level for spinning, prior to mixing into the polymer solution. For Comparison Example 6F, Comparison Example 7B, and Comparison Example 7C, 2,5-thiophenediylbis(5-tert-butyl-1,3-benzoxazole) was the additional additive.

The polymer solutions were dry-spun from DMAc into a column into which a stream of heated nitrogen was introduced, and groups of four filaments were coalesced to give 40 denier (44 dtex) spandex samples to which was applied about 4 wt % of a finish including 96 wt % silicone oil and 4 wt % magnesium stearate. The fiber was wound onto a package.

### Preparation of Examples and Remaining Comparison Examples

A polyurethaneurea polymer was prepared as described above. Another additive slurry was prepared by mixing together 0.3 wt % titanium dioxide (TiPure Type R706, available from E.I. DuPont de Nemours and Company), a physical mixture of huntite and hydromagnesite mineral particles (available from Minelco Specialties Ltd.) as described in U.S. Pat. No. 5,626,960 (hereby incorporated by reference), a blue toner, and a dilute solution of the polyurethaneurea polymer in DMAc. This slurry was media milled to reduce the particle size to an acceptable level for spinning. To form spinning solutions, the slurries were mixed into polymer solution so that the final spandex contained 4.0 wt % huntite/hydromagnesite, 0.3 wt % titanium dioxide, less than 15 ppm blue toner, 1.5 wt % Cyanox® 1790, 0.5 wt % Methacrol® 2462B, and 0.6 wt % silicone oil.

Additional additives, as indicated in the Tables, were also mixed into the polymer solution, either as a neat liquid or as a dispersion or solution of solids in DMAc, in quantities sufficient to give the indicated concentrations in the final spandex. For inorganic particulate additives, dispersions of the additives in DMAc were media milled in order to deagglomerate the solids and reduce the particle size to an acceptable level for spinning, prior to mixing into the polymer solution.

The polymer solutions were dry-spun from DMAc into a column into which a stream of heated nitrogen was introduced, and groups of four filaments were coalesced to give 40 denier (44 dtex) spandex samples to which was applied about 4 wt % of a finish including 96 wt % silicone oil and 4 wt % magnesium stearate. The fiber was wound onto a package.

Initial whiteness and whiteness retention data, after scouring and mock dyeing and after exposure to UV radiation for 4 hours, for spandex with an optical brightener is presented in the following Table. All samples contained 0.3 wt % titanium dioxide.

TABLE 3

| | Wt % | Opt. B. | CIE Whiteness | | |
|---|---|---|---|---|---|
| | Opt. B. | used | | After | After 4 h UV |
| Example # | used | (Note) | Initial | Scour | Exposure |
| Comp. Ex. 1 | — | — | 92 | 91 | 69 |
| Comp. Ex. 2A | 0.0040 | (1) | 111 | 108 | 64 |
| Comp. Ex. 2B | 0.010 | (1) | 119 | 115 | 58 |
| Comp. Ex. 2C | 0.035 | (1) | 83 | 79 | 41 |
| Comp. Ex. 3A | 0.035 | (2) | 111 | NM | NM |
| Comp. Ex. 3B | 0.120 | (2) | 106 | NM | NM |
| Comp. Ex. 4A | 0.010 | (3) | 110 | 109 | 54 |
| Comp. Ex. 4B | 0.035 | (3) | 119 | 118 | 54 |
| Comp. Ex. 4C | 0.120 | (3) | 120 | 118 | 50 |
| Comp. Ex. 4D | 0.417 | (3) | 116 | 115 | 42 |
| Comp. Ex. 4E | 1.445 | (3) | 98 | 96 | 27 |
| Comp. Ex. 5A | 0.010 | (4) | 118 | 106 | 66 |
| Comp. Ex. 5B | 0.035 | (4) | 134 | 118 | 67 |
| Comp. Ex. 5C | 0.120 | (4) | 110 | 134 | 70 |
| Comp. Ex. 5D | 0.417 | (4) | 92 | 92 | 43 |

Notes:
(1) The optical brightener used was 2,2′-(1,2-Ethenediyldi-4,1-phenylene)bisbenzoxazole.
(2) The optical brightener used was 7-(2H-naphtho[1,2-D]triazol-2-yl)-3-phenylcoumarin.
(3) The optical brightener used was 2,5-thiophenediylbis(5-tert-butyl-1,3-benzoxazole).
(4) The optical brightener used was 4,4′-bis(2-methoxystyryl)-1,1′-biphenyl.

The data in the Table above show an enhanced initial whiteness for spandex which comprises one of a variety of optical brighteners as compared to Comparison Example 1, which lacks an optical brightener. The effective amount of optical brightener falls within the general range of about 0.002 to about 5 weight percent, based on the weight of spandex. An effective amount of optical brightener is that which is sufficient to impart the desired level of initial whiteness to the spandex. The desired level of initial whiteness may be the maximum whiteness obtainable with the optimal amount of optical brightener, or it may be a level of whiteness which is higher than would be obtained without use of the optical brightener.

The data in the Table above also show that spandex including an optical brightener retains its whiteness after scouring and mock dyeing, a process which simulates the wet processing that would be performed on a fabric including spandex. The data also show that CIE whiteness of spandex decreases after about 4 hours of exposure to UV radiation. Although spandex including an optical brightener can have initial whiteness exceeding that of spandex without an optical brightener (for example Comparison Example 1), after about 4 hours of exposure to UV radiation the spandex with the optical brightener can be less white than the spandex lacking an optical brightener.

Initial whiteness and whiteness retention data, after scouring and mock dyeing and after exposure to UV radiation for 4 hours, for spandex with an optical brightener alone, or with titanium dioxide, or with an optical brightener in combination with titanium dioxide, is presented in the following Table. In the versus Control, “the numbers were obtained by taking the□column marked” difference of the initial CIE whiteness of the sample and the initial CIE whiteness of the appropriate control. For Comparison Examples 6B through 6F and Example 1A through 1D, the control sample was Comparison Example 6A. For Comparison Examples 7B through 7D and Examples 2A and 2B, the control sample was Comparison Example 7A.

TABLE 4

| | | | CIE Whiteness | | | |
|---|---|---|---|---|---|---|
| | | | | versus | | |
| | Wt % | Wt % | | Control | After | After 4 h UV |
| Example # | TiO₂ | Opt. B. | Initial | □ | Scour | Exposure |
| Comp. Ex. 6A | — | — | 75 | — | 70 | 37 |
| Comp. Ex. 6B | 0.3 | — | 83 | 8 | 81 | 53 |
| Comp. Ex. 6C | 0.6 | — | 86 | 11 | 84 | 62 |
| Comp. Ex. 6D | 0.9 | — | 84 | 9 | 82 | 66 |
| Comp. Ex. 6E | 1.2 | — | 86 | 11 | 84 | 69 |
| Comp. Ex. 6F | — | 0.12 | 99 | 24 | 82 | 40 |
| 1A | 0.3 | 0.12 | 117 | 42 | 106 | 39 |
| 1B | 0.6 | 0.12 | 116 | 41 | 106 | 48 |
| 1C | 0.9 | 0.12 | 116 | 41 | 112 | 52 |
| 1D | 1.2 | 0.12 | 114 | 39 | 109 | 55 |
| Comp. Ex. 7A | — | — | 81 | — | 74 | 40 |
| Comp. Ex. 7B | — | 0.1 | 105 | 24 | 95 | 45 |
| Comp. Ex. 7C | — | 0.2 | 101 | 20 | 92 | 43 |
| Comp. Ex. 7D | 0.3 | — | 94 | 13 | 90 | 61 |
| 2A | 0.3 | 0.1 | 124 | 43 | 120 | 49 |
| 2B | 0.3 | 0.2 | 122 | 41 | 119 | 48 |

Note:
The optical brightener used for the indicated samples was 2,5-thiophenediylbis(5-tert-butyl-1,3-benzoxazole).

The data in the Table above show that the initial CIE whiteness of spandex can be enhanced by the addition of an optical brightener (Comparison Example 6F, Comparison Example 7B, and Comparison Example 7C) or by the addition of titanium dioxide (Comparison Examples 6B through 6E and Comparison Example 7D) relative to spandex which contains neither an optical brightener nor titanium dioxide (Comparison Example 6A and Comparison Example 7A). The data also show that the combination of an optical brightener and titanium dioxide, as in Examples 1A through 1D, 2A, and 2B, provides even higher CIE whiteness than would be expected from each additive alone based on simple addition of the additive's effects. For example, while the addition of about 0.3 to about 1.2 weight percent titanium dioxide was shown to increase the initial whiteness of spandex by about 8-11 CIE units, and while the use of an optical brightener alone was shown to increase the initial whiteness of the spandex by about 20-24 CIE units, the use of titanium dioxide in combination with an optical brightener was shown to boost the initial whiteness of the spandex by at least about 40 CIE units. As discussed previously, it is surprising that the combination of titanium dioxide and an optical brightener provides enhanced whiteness to the spandex as it is generally known that titanium dioxide reduces the effectiveness of optical brighteners.

The data in the Table above also show that whiteness declines somewhat after scouring and mock dyeing. The data also show that after 4 hours of exposure to UV radiation, all the spandex samples have decreased whiteness. Addition of only an optical brightener (Comparison Example 6F, Comparison Example 7B, and Comparison Example 7C) gives whiteness retention results which are slightly better than the additive-free controls (Comparison Example 6A and Comparison Example 7A). Whiteness retention is generally improved for spandex including an optical brightener and titanium dioxide, particularly as the amount of titanium dioxide increases. The best whiteness retention after 4 hours of exposure to UV radiation is observed for samples containing higher amounts of titanium dioxide and no optical brightener.

In Tables 5 and 6 are presented initial whiteness data and whiteness retention data for spandex after scouring and mock dyeing, and after environmental exposure to combustion fumes, nitrogen dioxide fumes, heat, chlorine, and UV radiation. All spandex samples in these Tables also contained 0.3 wt % titanium dioxide.

TABLE 5

| | | | | CIE Whiteness After | | | | |
|---|---|---|---|---|---|---|---|---|
| | | Wt % UV | | Environmental Exposure to | | | | |
| | Wt % | Screener | Initial CIE | Fume | NO₂ | Thermal | Chlorine | UV |
| Ex # | Opt. B. | (4) | Whiteness | 36 h | 24 h | 105 min | 5 h | 4 h |
| Comp. Ex. 1 | — | — | 92 | 66 | 59 | 52 | 63 | 69 |
| Comp. Ex. 4C | 0.12 (1) | — | 122 | 105 | 96 | 89 | 99 | 51 |
| 3A | 0.12 (1) | 0.1 | 118 | 94 | 91 | 91 | 94 | 53 |
| 3B | 0.12 (1) | 0.2 | 117 | 92 | 87 | 92 | 90 | 54 |
| Comp. Ex. 2B | 0.01 (2) | — | 119 | 97 | 87 | 77 | 89 | 58 |
| Comp. Ex. 5C | 0.12 (3) | — | 110 | 107 | 98 | 96 | 103 | 70 |
| 4 | 0.12 (3) | 0.2% | 107 | 86 | 86 | 77 | 77 | 77 |

Notes:
(1) The optical brightener used was 2,5-thiophenediylbis(5-tert-butyl-1,3-benzoxazole).
(2) The optical brightener used was 2,2′-(1,2-ethenediyldi-4,1-phenylene)bisbenzoxazole.
(3) The optical brightener used was 4,4′-bis(2-methoxystyryl)-1,1′-biphenyl.
(4) The UV screener used was 2-[4,6-bis(2,4-dimethylphenyl)-1,3,5-triazin-2-yl]-5-(octyloxy)phenol.

TABLE 6

| | | | | CIE Whiteness After | | | | |
|---|---|---|---|---|---|---|---|---|
| | Wt % | Wt % UV | | Environmental Exposure to | | | | |
| | Opt. B. | Screener | Initial CIE | Fume | NO₂ | Thermal | Chlorine | UV |
| Ex # | (1) | (2) | Whiteness | 36 h | 68 h | 90 min | 5 hr | 4 hr |
| Comp. Ex. 8A | — | — | 92 | 72 | 60 | 56 | 60 | 68 |
| Comp. Ex. 8B | 0.05 | — | 137 | 97 | 89 | 98 | 89 | 56 |
| 5A | 0.05 | 0.2 | 129 | 90 | 75 | 88 | 75 | 68 |
| 5B | 0.05 | 0.4 | 123 | 94 | 69 | 86 | 69 | 68 |
| Comp. Ex. 8C | 0.1 | — | 115 | 108 | 93 | 107 | 90 | 58 |
| 5C | 0.1 | 0.2 | 107 | 92 | 80 | 108 | 81 | 65 |
| 5D | 0.1 | 0.4 | 105 | 90 | 69 | 93 | 75 | 67 |
| Comp. Ex. 8D | 0.2 | — | 106 | 92 | 59 | 115 | 71 | 48 |
| 5E | 0.2 | 0.2 | 99 | 84 | 58 | 109 | 59 | 56 |
| 5F | 0.2 | 0.4 | 97 | 78 | 54 | 104 | 61 | 60 |

Notes:
(1) Except for Comparison Example 8A which did not contain an optical brightener, the optical brightener used for these samples was 4,4′-bis(2-methoxystyryl)-1,1′-biphenyl.
(2) The UV screener used was 2-[4,6-bis(2,4-dimethylphenyl)-1,3,5-triazin-2-yl]-5-(octyloxy)phenol.

Data in Tables 5 and 6 show that initial whiteness is enhanced for spandex which contains an optical brightener, or an optical brightener in combination with a UV screener. Such spandex also shows generally significantly improved whiteness retention after exposure to combustion fumes, after exposure to nitrogen dioxide fumes, after thermal exposure, and after chlorine exposure than does spandex which lacks an optical brightener or the combination of an optical brightener and a UV screener.

Data in Tables 5 and 6 also show that whiteness retention after 4 hours of exposure to UV radiation is poor for spandex containing 4,4′-bis(2-methoxystyryl)-1,1′-biphenyl as an optical brightener but with no UV screener, and generally better for spandex including an optical brightener and a UV screener. Four of the inventive spandex samples including both an optical brightener and a UV screener (Examples 5A, 5B, 5C, and 5D) showed whiteness retention comparable to that of spandex without an optical brightener or a UV screener, while one of them, Example 4, showed higher CIE whiteness (better whiteness retention) than did the spandex without an optical brightener or a UV screener (Comparison Example 1 and Comparison Example 8A). Thus, whiteness retention after environmental exposure appears best overall for spandex including an optical brightener and a UV screener. Spandex Examples 4, 5A, 5B, 5C, and 5D are seen to have an effective amount of optical brightener and UV screener, for example about 0.05 weight percent to about 0.12 weight percent optical brightener together with about 0.2 to about 0.4 weight percent UV screener.

The following Table presents initial whiteness and whiteness retention data after 4 hours of UV exposure for spandex samples including an optical brightener and a UV screener. Comparison is made to spandex lacking both an optical brightener and a UV screener (Comparison Example 9A) and to spandex which contains an optical brightener but no UV screener (Comparison Example 9B and Comparison Example 10).

TABLE 7

| | Wt % UV | | CIE Whiteness | |
|---|---|---|---|---|
| | Screener | UV Screener | | After 4 hrs |
| Example # | (1) | Used | Initial | UV |
| Comp. Ex. 9A | — | — | 91 | 63 |
| Comp. Ex. 9B | — | — | 118 | 51 |
| 6A | 0.2 | (2) | 110 | 61 |
| 6B | 0.4 | (2) | 102 | 63 |
| 6C | 0.6 | (2) | 101 | 60 |
| 6D | 0.2 | (3) | 114 | 55 |
| 6E | 0.4 | (3) | 105 | 56 |
| 6F | 0.6 | (3) | 105 | 58 |
| 6G | 0.2 | (4) | 108 | 62 |
| 6H | 0.4 | (4) | 101 | 66 |
| 6I | 0.6 | (4) | 96 | 67 |
| Comp. Ex. 10 | — | — | 123 | 45 |
| 7A | 0.2 | (5) | 118 | 59 |
| 7B | 0.4 | (5) | 111 | 65 |
| 7C | 0.6 | (5) | 104 | 67 |
| 7D | 0.2 | (6) | 119 | 54 |
| 7E | 0.4 | (6) | 121 | 57 |
| 7F | 0.6 | (6) | 118 | 61 |
| 7G | 0.2 | (7) | 110 | 55 |
| 7H | 0.4 | (7) | 107 | 63 |
| 7I | 0.6 | (7) | 101 | 67 |

Notes:
(1) All samples except those for Comparison Examples 9A, 9B, and 10 have 0.1 wt % 4,4′-bis(2-methoxystyryl)-1,1′-biphenyl as optical brightener. All samples also contained 0.3 wt % titanium dioxide.
(2) The UV screener used was 2-(2′-hydroxy-3′,5′-di(1,1-dimethylbenzyl))-2H-benzotriazole.
(3) The UV screener used was 2-hydroxy-4-n-octyloxybenzophenone.
(4) The UV screener used was 2-4,6-diphenyl-1,3,5-triazin-2-yl)-5-hexyloxy-phenol.
(5) The UV screener used was 2-(2′-hydroxy-3′.5′-di-tert-amylphenyl)benzotriazole.
(6) The UV screener used was 2-ethyl-2′-ethoxy-oxalanilide.
(7) The UV screener used was 2-(2H-benzotriazol-2-yl)-6-dodecyl-4-methylphenol.

Data in Table 7 show that the spandex of the invention, which comprises both an optical brightener and a UV screener, has enhanced initial whiteness and improved whiteness retention after 4 hours of exposure to UV radiation. While initial whiteness relative to that of an additive-free control (Comparison Example 9A) is increased by addition of an optical brightener alone (Comparison Example 9B and Comparison Example 10), whiteness retention after exposure to UV radiation decreases unless an UV screener is also present.

Together with spandex Examples 4, 5A, 5B, 5C, and 5D from Tables 5 and 6, spandex Examples 6A through 61 and 7A through 71 demonstrate the amounts of optical brightener and UV screener which are sufficient to provide enhanced initial CIE whiteness and improved whiteness retention after 4 hours of exposure to UV radiation. For example, about 0.05 weight percent to about 0.1 weight percent optical brightener (for example, 4,4′-bis(2-methoxystyryl)-1,1′-biphenyl or 2,5-thiophenediylbis(5-tert-butyl-1,3-benzoxazole)) in combination with about 0.2 weight percent to about 0.6 weight percent UV screener can provide spandex with enhanced initial CIE whiteness and improved whiteness retention after 4 hours of UV exposure.

The following Table presents spandex initial whiteness, spandex whiteness retention data after 4 hours of UV radiation exposure or after exposure to 195° C. for 180 seconds, and spandex property data after 12 hours of exposure to UV radiation. Some spandex samples were subjected to a temperature of 195° C. for 180 seconds (sec) using the same general method as for the thermal degradation tests described earlier. This was done in order to simulate the temperature that could be experienced under molding or heatsetting conditions. No actual molding was involved. The CIE whiteness of spandex after the 195° C. test are given in the column labeled “After 180 sec at 195° C.”

TABLE 8

| | | | CIE Whiteness | | | Property Data After | | |
|---|---|---|---|---|---|---|---|---|
| | | UV | | After | After | 12 Hour UV Exposure | | |
| Example # | Wt % UV | Screener | | 4 hr | 180 sec at | % UV | % ELO | % TEN |
| (Note) | Screener | Used | Initial | UV | 195° C. | growth | ret. | ret. |
| Comp. Ex. 9A (1) | — | — | 91 | 63 | — | 16.1 | 105.4 | 56.4 |
| Comp. Ex. 9B (2) | — | — | 118 | 52 | — | broke | — | — |
| 7B (2) | 0.4 | (5) | 111 | 66 | — | 15.8 | 53.8 | 16.3 |
| 5D (2) | 0.4 | (6) | 105 | 67 | — | 15.9 | 50.7 | 19.5 |
| 6H (2) | 0.4 | (7) | 101 | 66 | — | 13.4 | 82.7 | 37.8 |
| 8A (2), (4) | 0.4 | (6) | 105 | 60 | — | 13.3 | 91.8 | 52.3 |
| Comp. Ex. 11A (3) | — | — | 93 | 57.3 | 57 | 16.5 | 95.2 | 46.7 |
| Comp. Ex. 11B (1), (3) | — | — | 129 | 57.4 | 92 | broke | — | — |
| 9A (3) | 0.2 | (6) | 116 | 67.2 | — | 24.7 | — | — |
| 9B (3) | 0.4 | (6) | 115 | 68.6 | — | 20.4 | 56.5 | 15.7 |
| 9C (3) | 0.6 | (6) | 122 | 70.4 | — | 15.3 | 63.1 | 26.5 |
| 9D (3) | 0.2 | (7) | 124 | 77.2 | 81 | 21.5 | 44.7 | 20.0 |
| 9E (3) | 0.4 | (7) | 117 | 76.3 | 81 | 18.1 | 50.2 | 14.9 |
| 9F (3) | 0.6 | (7) | 111 | 72.3 | 70 | 15.8 | 83.3 | 40.6 |

Notes:
All samples contained 0.3 wt % titanium dioxide.
(1) This sample contained no optical brightener.
(2) These samples contained 0.1 weight percent 4,4′-bis(2-methoxystyryl)-1,1′-biphenyl as the optical brightener.
(3) These samples contained 0.08 weight percent 4,4′-bis(2-methoxystyryl)-1,1′-biphenyl as the optical brightener.
(4) This sample also contained 1.5 wt % 2,5-pyrrolidinedione, N-acetyl-3-dodecyl-1-(2,2,6,6-tetramethyl-4-piperidinyl), added as Sanduvor ® 3058 available from Clariant.
(5) The UV screener used was 2-(2′-hydroxy-3′.5′-di-tert-amylphenyl)benzotriazole.
(6) The UV screener used was 2-[4,6-bis(2,4-dimethylphenyl)-1,3,5-triazin-2-yl]-5-(octyloxy)phenol.
(7) The UV screener used was 2-4,6-diphenyl-1,3,5-triazin-2-yl)-5-hexyloxy-phenol.

Addition of an optical brightener gives spandex having poor property retention after extended exposure to UV radiation (12 hours), as seen by the spandex breaking during the percent growth test subsequent to the UV exposure (Comparison Example 9B). Addition of optical brightener and UV screener can provide spandex which has improved (lower) percent growth after UV exposure, relative to spandex without either additive (Comparison Example 9A and Comparison Example 11A). Spandex including an optical brightener and an UV screener can also have improved retention of percent elongation at break and percent tenacity at break (determined by comparison to the sample properties before extended UV exposure) relative to spandex containing only an optical brightener. Including a hindered amine light stabilizer with the optical brightener and UV screener in spandex, as in Example 8A, gave property retention after 12 hours of UV exposure which was comparable to that of the control spandex without these additives. The combination of optical brightener, UV screener, and a hindered amine light stabilizer also provided desirable enhanced initial whiteness.

Two warp knit fabrics were prepared representing a control fabric and a fabric of the present invention. The control fabric was knit from 78% of a polyamide 66 yarn and 22% of a 44 decitex LYCRA® spandex yarn. The inventive fabric was knit from a 78% of a polyamide 66 yarn and a 44 decitex inventive spandex yarn including an optical brightener and a UV screener.

The fabric was knitted on a Liba Copcentra 32E-2K warp knitting machine, Ground Bar 1-0/1-2, Run Ins 49 cms, Front Bar 2-3/1-0, Run Ins 149 cms, 25 courses per cm 25, with the machine running at 2000 courses per minute.

The fabric samples were pre-heat set at 195° C. for 30 seconds on a Babcocks Stenter (typical trade pre-heat setting conditions). CIE whiteness readings were taken with the control fabric having CIE=57.35 and the inventive fabric having CIE=73.66.

The fabrics were then scoured in a In a Thies TRD Jet dye machine to remove the impurities, oils etc, using 1% non-ionic detergent 2 g/l alkali at pH 10, processed for 30 minutes at 80° C., and rinsed. Then an optical brightening agent was applied (to whiten the fabric) in the same dye machine, starting at 40° C. with a 1° C. rate of rise to 98° C. processed for 45 minutes at pH6 (typical trade processing conditions). CIE Whiteness readings were taken after this process with the control fabric having CIE=140.61 and the inventive fabric having CIE=154.77. The fabrics were then washed multiple times in a domestic washing machine at 60° C. with CIE whiteness readings taken every 5 washes. These results are shown in Table 9.

TABLE 9

CIE Whiteness

| Number of Washes | Control Fabric | Inventive Fabric |
|---|---|---|
| 5 | 130.48 | 150.77 |
| 10 | 118.68 | 146.83 |
| 15 | 115.22 | 141.33 |
| 20 | 104.97 | 138.21 |
| 25 | 122.24 | 132.78 |
| 30 | 93.01 | 130.72 |
| 35 | 96.68 | 131.27 |
| 40 | 89.92 | 127.71 |
| 45 | 86.92 | 126.90 |
| 50 | 83.43 | 123.56 |

The results in Table 9 demonstrated the improvement in the initial white value and whiteness retention properties after multiple domestic washings of the inventive fabric in comparison to the control fabric.

While there have been described what are presently believed to be the preferred embodiments of the invention, those skilled in the art will realize that changes and modifications may be made thereto without departing from the spirit of the invention, and it is intended to include all such changes and modifications as fall within the true scope of the invention.

What is claimed is:

1. Spandex having an initial CIE whiteness of at least about 95 as measured by AATCC Test Method 110-1994, the spandex comprising: an optical brightener selected from the group consisting of an oxazole, a biphenyl, a coumarin, a stilbene, a pyrazolene, a rhodamine, and a fluorescein, or a combination of such members; and an ultraviolet screener selected from the group consisting of a triazine, a benzotriazole, an oxalanilide, a benzophenone, and a bismalonate, or a combination of such members.

2. The spandex of claim 1 wherein the optical brightener is selected from the group consisting of an oxazole, a biphenyl, and a coumarin, or a combination of such members, and wherein the ultraviolet screener is selected from the group consisting of a triazine, a benzotriazole, and an oxalanilide, or a combination of such members.

3. The spandex of claim 1 wherein the optical brightener is selected from the group consisting of 2,5-thiophenediylbis(5-tert-butyl-1,3-benzoxazole), 4,4′-bis(2-methoxystyryl)-1,1′-biphenyl, 2,2′-(1,2-ethenediyldi-4,1-phenylene)bisbenzoxazole, and 7-(2H-naphtho[1,2-D]triazol-2-yl)-3-phenylcoumarin, or a combination of such members and the ultraviolet screener is selected from the group consisting of 2-(2′-hydroxy-3′,5′-di(1,1-dimethylbenzyl))-2H-benzotriazole, 2-hydroxy-4-n-octyloxybenzophenone, 2-4,6-diphenyl-1,3,5-triazin-2-yl)-5-hexyloxy-phenol, 2-(2′-hydroxy-3′,5′-di-tert-amylphenyl)benzotriazole, 2-ethyl-2′-ethoxy-oxalanilide, 2-(2H-benzotriazol-2-yl)-6-dodecyl-4-methylphenol, and 2-[4,6-bis(2,4-dimethylphenyl)-1,3,5-triazin-2-yl]-5-(octyloxy)phenol, or a combination of such members.

4. The spandex of claim 3 wherein the optical brightener is 2,5-thiophenediylbis(5-tert-butyl-1,3-benzoxazole) and the ultraviolet screener is 2-[4,6-bis(2,4-dimethylphenyl)-1,3,5-triazin-2-yl]-5-(octyloxy)phenol.

5. The spandex of claim 3 wherein the optical brightener is 2,5-thiophenediylbis(5-tert-butyl-1,3-benzoxazole) and the ultraviolet screener is 2-4,6-diphenyl-1,3,5-triazin-2-yl)-5-hexyloxy-phenol.

6. The spandex of claim 3 wherein the optical brightener is 4,4′-bis(2-methoxystyryl)-1,1′-biphenyl and the ultraviolet screener is 2-[4,6-bis(2,4-dimethylphenyl)-1,3,5-triazin-2-yl]-5-(octyloxy)phenol.

7. The spandex of claim 3 wherein the optical brightener is 4,4′-bis(2-methoxystyryl)-1,1′-biphenyl and the ultraviolet screener is 2-4,6-diphenyl-1,3,5-triazin-2-yl)-5-hexyloxy-phenol.

8. Spandex comprising: an optical brightener selected from the group consisting of an oxazole, a biphenyl, a coumarin, a stilbene, a pyrazolene, a rhodamine, and a fluorescein, or a combination of such members; and an ultraviolet screener selected from the group consisting of a triazine, a benzotriazole, an oxalanilide, a benzophenone, and a bismalonate, or a combination of such members, in an amount sufficient for the percent growth of the spandex after 12 hours of exposure to ultraviolet radiation to be less than 16%.

9. The spandex of claim 8, wherein the percent retention of elongation at break after about 12 hours of exposure to ultraviolet radiation is at least about 60%.

10. The spandex of claim 8, further comprising a hindered amine light stabilizer.

11. The spandex of claim 1 wherein, after about 4 hours of exposure to ultraviolet radiation, the spandex has a CIE whiteness of at least about 55.

12. The spandex of claim 11, wherein the optical brightener is selected from the group consisting of 2,5-thiophenediylbis(5-tert-butyl-1,3-benzoxazole), 4,4′-bis(2-methoxystyryl)-1,1′-biphenyl, 2,2′-(1,2-ethenediyldi-4,1-phenylene)bisbenzoxazole, and 7-(2H-naphtho[1,2-D]triazol-2-yl)-3-phenylcoumarin, or a combination of such members and the ultraviolet screener is selected from the group consisting of 2-(2′-hydroxy-3′,5′-di(1,1-dimethylbenzyl))-2H-benzotriazole, 2-hydroxy-4-n-octyloxybenzophenone, 2-4,6-diphenyl-1,3,5-triazin-2-yl)-5-hexyloxy-phenol, 2-(2′-hydroxy-3′,5′-di-tert-amylphenyl)benzotriazole, 2-ethyl-2′-ethoxy-oxalanilide, 2-(2H-benzotriazol-2-yl)-6-dodecyl-4-methylphenol, and 2-[4,6-bis(2,4-dimethylphenyl)-1,3,5-triazin-2-yl]-5-(octyloxy)phenol, or a combination of such members.

13. The spandex of claim 12, wherein the optical brightener is 2,5-thiophenediylbis(5-tert-butyl-1,3-benzoxazole) and the ultraviolet screener is 2-[4,6-bis(2,4-dimethylphenyl)-1,3,5-triazin-2-yl]-5-(octyloxy)phenol.

14. The spandex of claim 12 wherein the optical brightener is 2,5-thiophenediylbis(5-tert-butyl-1,3-benzoxazole) and the ultraviolet screener is 2-4,6-diphenyl-1,3,5-triazin-2-yl)-5-hexyloxy-phenol.

15. The spandex of claim 12, wherein the optical brightener is 4,4′-bis(2-methoxystyryl)-1,1′-biphenyl and the ultraviolet screener is 2-[4,6-bis(2,4-dimethylphenyl)-1,3,5-triazin-2-yl]-5-(octyloxy)phenol.

16. The spandex of claim 12 wherein the optical brightener is 4,4′-bis(2-methoxystyryl)-1,1′-biphenyl and the ultraviolet screener is 2-4,6-diphenyl-1,3,5-triazin-2-yl)-5-hexyloxy-phenol.

17. Fabric comprising the spandex of claim 1.

18. Fabric comprising the spandex of claim 8.

19. Fabric comprising the spandex of claim 11.

20. A fabric comprising: at least one weight percent spandex, the spandex comprising an optical brightener selected from the group consisting of an oxazole, a biphenyl, a coumarin, a stilbene, a pyrazolene, a rhodamine, and a fluorescein, or a combination of such members; and an ultraviolet screener selected from the group consisting of a triazine, a benzotriazole, an oxalanilide, a benzophenone, and a bismalonate, or a combination of such members, wherein the fabric has whiteness retention greater than that of a comparison fabric made in the same way but with spandex lacking an optical brightener and a UV screener.

21. A garment or textile article comprising the fabric of claim 17.

22. A method for imparting whiteness to spandex, the method comprising:
a) contacting a polyether glycol selected from the group consisting of polyethyleneether glycol, polytrimethyleneether glycol, poly(tetramethyleneether) glycol, poly(tetramethylene-co-2-methyltetramethyleneether) glycol, poly(tetramethylene-co-ethyleneether) glycol and mixtures thereof, or a polyester glycol selected from the group consisting of reaction products of (i) ethylene glycol, propylene glycol, butylene glycol, 2,2-dimethyl-1,3-propanediol, and mixtures thereof, and (ii) terephthalic acid, succinic acid, adipic acid, azelaic acid, sebacic acid, and dodecanedioic acid, and mixtures thereof, with at least one diisocyanate;
b) contacting the reaction product of step a) with at least one chain extender and, optionally, with a chain terminator;
c) contacting the reaction product of step b) with an optical brightener and an ultraviolet screener in an amount sufficient to impart whiteness to the spandex; and
d) spinning the product of c) to form spandex,
wherein the optical brightener is selected from the group consisting of an oxazole, a biphenyl, a coumarin, a stilbene, a pyrazolene, a rhodamine, and a fluorescein, or a combination of such members; and the ultraviolet screener is selected from the group consisting of a triazine, a benzotriazole, an oxalanilide, a benzophenone, and a bismalonate, or a combination of such members.

23. A method for adjusting the initial whiteness of spandex to a desired level, the method comprising:
a) contacting a polyether glycol selected from the group consisting of polyethyleneether glycol, polytrimethyleneether glycol, poly(tetramethyleneether) glycol, poly(tetramethylene-co-2-methyltetramethyleneether) glycol, poly(tetramethylene-co-ethyleneether) glycol and mixtures thereof, or a polyester glycol selected from the group consisting of reaction products of (i) ethylene glycol, propylene glycol, butylene glycol, 2,2-dimethyl-1,3-propanediol, and mixtures thereof, and (ii) terephthalic acid, succinic acid, adipic acid, azelaic acid, sebacic acid, and dodecanedioic acid, and mixtures thereof, with at least one diisocyanate;
b) contacting the reaction product of step a) with at least one chain extender and, optionally, with a chain terminator;
c) contacting the reaction product of step b) with an optical brightener and an ultraviolet screener in an amount sufficient to provide the desired whiteness level to the spandex; and
d) spinning the product of c) to form spandex,
wherein the optical brightener is selected from the group consisting of an oxazole, a biphenyl, a coumarin, a stilbene, a pyrazolene, a rhodamine, and a fluorescein, or a combination of such members; and the ultraviolet screener is selected from the group consisting of a triazine, a benzotriazole, an oxalanilide, a benzophenone, and a bismalonate, or a combination of such members.

24. A method for imparting whiteness retention after scouring or after environmental exposure to combustion fumes, nitrogen dioxide fumes, ultraviolet radiation, heat, or chlorine bleach to spandex, the method comprising:
a) contacting a polyether glycol selected from the group consisting of polyethyleneether glycol, polytrimethyleneether glycol, poly(tetramethyleneether) glycol, poly(tetramethylene-co-2-methyltetramethyleneether) glycol, poly(tetramethylene-co-ethyleneether) glycol and mixtures thereof, or a polyester glycol selected from the group consisting of reaction products of (i) ethylene glycol, propylene glycol, butylene glycol, 2,2-dimethyl-1,3-propanediol, and mixtures thereof, and (ii) terephthalic acid, succinic acid, adipic acid, azelaic acid, sebacic acid, and dodecanedioic acid, and mixtures thereof, with at least one diisocyanate;
b) contacting the reaction product of step a) with at least one chain extender and, optionally, with a chain terminator;
c) contacting the reaction product of step b) with an optical brightener and an ultraviolet screener in an amount sufficient to provide whiteness retention to the spandex after scouring or after environmental exposure; and
d) spinning the product of c) to form spandex,
wherein the optical brightener is selected from the group consisting of an oxazole, a biphenyl, a coumarin, a stilbene, a pyrazolene, a rhodamine, and a fluorescein, or a combination of such members; and the ultraviolet screener is selected from the group consisting of a triazine, a benzotriazole, an oxalanilide, a benzophenone, and a bismalonate, or a combination of such members.

25. A method for imparting to spandex property retention of tenacity at break after 12 hours exposure to ultraviolet radiation, the method comprising:
a) contacting a polyether glycol selected from the group consisting of polyethyleneether glycol, polytrimethyleneether glycol, poly(tetramethyleneether) glycol, poly(tetramethylene-co-2-methyltetramethyleneether) glycol, poly(tetramethylene-co-ethyleneether) glycol and mixtures thereof, or a polyester glycol selected from the group consisting of reaction products of (i) ethylene glycol, propylene glycol, butylene glycol, 2,2-dimethyl-1,3-propanediol, and mixtures thereof, and (ii) terephthalic acid, succinic acid, adipic acid, azelaic acid, sebacic acid, and dodecanedioic acid, and mixtures thereof, with at least one diisocyanate;
b) contacting the reaction product of step a) with at least one chain extender and, optionally, with a chain terminator;
c) contacting the reaction product of step b) with an optical brightener and an ultraviolet screener, and optionally a hindered amine light stabilizer, in an amount sufficient to impart property retention of tenacity at break to the spandex after 12 hours exposure to ultraviolet radiation; and
d) spinning the product of c) to form spandex,
wherein the optical brightener is selected from the group consisting of an oxazole, a biphenyl, a coumarin, a stilbene, a pyrazolene, a rhodamine, and a fluorescein, or a combination of such members; and the ultraviolet screener is selected from the group consisting of a triazine, a benzotriazole, an oxalanilide, a benzophenone, and a bismalonate, or a combination of such members.

26. A method for imparting to spandex property retention of elongation at break after 12 hours exposure to ultraviolet radiation, the spandex comprising an optical brightener and a UV screener, the method comprising:
a) contacting a polyether glycol selected from the group consisting of polyethyleneether glycol, polytrimethyleneether glycol, poly(tetramethyleneether) glycol, poly(tetramethylene-co-2-methyltetramethyleneether) glycol, poly(tetramethylene-co-ethyleneether) glycol and mixtures thereof, or a polyester glycol selected from the group consisting of reaction products of (i) ethylene glycol, propylene glycol, butylene glycol, 2,2-dimethyl-1,3-propanediol, and mixtures thereof, and (ii) terephthalic acid, succinic acid, adipic acid, azelaic acid, sebacic acid, and dodecanedioic acid, and mixtures thereof, with at least one diisocyanate;
b) contacting the reaction product of step a) with at least one chain extender and, optionally, with a chain terminator;
c) contacting the reaction product of step b) with an optical brightener and an ultraviolet screener, and optionally a hindered amine light stabilizer, in an amount sufficient to impart property retention of elongation at break to the spandex after 12 hours exposure to ultraviolet radiation; and
d) spinning the product of c) to form spandex,
wherein the optical brightener is selected from the group consisting of an oxazole, a biphenyl, a coumarin, a stilbene, a pyrazolene, a rhodamine, and a fluorescein, or a combination of such members; and the ultraviolet screener is selected from the group consisting of a triazine, a benzotriazole, an oxalanilide, a benzophenone, and a bismalonate, or a combination of such members.

27. A composition comprising spandex, an optical brightener and an antioxidant including an unsymmetrically di-hindered hydroxyphenyl group; said composition being free of a UV screener.

28. The composition of claim 27, wherein said antioxidant is selected from 1,3,5-tris(2,6-dimethyl-3-hydroxy-4-t-butylbenzyl) isocyanurate, ethylene-1,2-bis(oxyethylene)bis[3-(5-t-butyl-4-hydroxy-m-tolyl)propionate], and combinations thereof.
